(19) United States
(12) Patent Application Publication
(10) Pub. No.: US 2010/0055602 A1
(43) Pub. Date: Mar. 4, 2010

(54) Liquid Developer and Image Forming Method

(75) Inventor: Takashi TESHIMA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/537,122

(22) Filed: Aug. 6, 2009

(30) Foreign Application Priority Data
Sep. 3, 2008 (JP) 2008-226516

(51) Int. Cl. G03G 9/13; G03G 13/20

(52) U.S. Cl. 430/114; 430/117.5

(57) ABSTRACT

A liquid developer includes: toner particles containing a rosin resin; an insulating liquid containing an epoxy-modified compound in liquid form; and a cationic photopolymerization initiator.

### CROSS-REFERENCE TO RELATED APPLICATION

The entire disclosure of Japanese Patent Application No. 2008-226516, filed Sep. 3, 2008 is expressly incorporated by reference herein.

### BACKGROUND

1. Technical Field

The present invention relates to a liquid developer and an image forming method.

2. Related Art

As a developer for developing an electrostatic latent image formed on a latent image holding member, a liquid developer has been known that contains an electrically insulating supporting liquid (insulating liquid) having dispersed therein a toner constituted by materials containing a colorant, such as a pigment, and a binder resin.

As the toner particles constituting the liquid developer, such resin materials have been used as a polyester resin, a styrene-acrylate ester copolymer and an epoxy resin. The resin materials are convenient in handling and provide good coloring property of a resulting image and good fixing property.

However, the known liquid developer has low affinity between the resin material constituting the toner particles and the insulating liquid, and it is difficult to disperse the toner particles sufficiently in the insulating liquid. Furthermore, the known liquid developer cannot provide a sufficient fixing strength of a toner image to a recording medium due to the insulating liquid intervening between the toner particles and the recording medium upon fixing.

For enhancing the dispersibility of the toner particles, there have been such an attempt that a rosin resin, which has high affinity with the insulating liquid, is used as the resin material constituting the toner particles (see, for example, Japanese Patent No. 3,332,961).

However, the liquid developer disclosed in Japanese Patent No. 3,332,961 cannot provide a sufficient fixing strength between a toner image and a recording medium since the insulating liquid intervening between the toner particles and the recording medium still impairs the toner image from being fixed, although the toner particles have good dispersibility.

### SUMMARY

An advantage of some aspects of the invention is to provide such a liquid developer that is excellent in long-term dispersion stability of toner particles and is excellent in fixing property of toner particles to a recording medium, and to provide an image forming method using the liquid developer.

The invention includes the following aspects.

According to an aspect of the invention, a liquid developer contains:

toner particles containing a rosin resin;

an insulating liquid containing an epoxy-modified compound in liquid form; and

a cationic photopolymerization initiator.

It is preferred in the liquid developer according to the aspect of the invention that the toner particles contain a polyester resin, in addition to the rosin resin.

It is preferred in the liquid developer according to the aspect of the invention that the toner particles contain toner mother particles containing the rosin resin having been surface-modified with a polyalkyleneimine.

It is preferred in the liquid developer according to the aspect of the invention that the polyalkyleneimine is polyethyleneimine.

It is preferred in the liquid developer according to the aspect of the invention that the epoxy-modified compound is an epoxidized vegetable oil obtained by epoxy-modifying a vegetable oil.

It is preferred in the liquid developer according to the aspect of the invention that the vegetable oil to be epoxy-modified contains as a constitutional component an unsaturated fatty acid having two or more unsaturated double bonds.

It is preferred in the liquid developer according to the aspect of the invention that the liquid developer satisfies the relationship, 0≦I₁/I₂≦0.17 and 70≦I₂≦220, wherein I₁ represents an iodine value of the epoxidized vegetable oil, and I₂ represents an iodine value of the vegetable oil before being epoxy-modified.

It is preferred in the liquid developer according to the aspect of the invention that the insulating liquid contains a fatty acid monoester.

It is preferred in the liquid developer according to the aspect of the invention that the cationic photopolymerization initiator is an aromatic sulfonium salt or an aromatic iodonium salt.

It is preferred in the liquid developer according to the aspect of the invention that the insulating liquid further contains a sensitizer.

It is preferred in the liquid developer according to the aspect of the invention that the rosin resin contains at least one of a maleic acid-modified rosin resin, a phenol-modified rosin resin and a polyester-modified rosin resin.

According to another aspect of the invention, an image forming method contains:

forming plural monochrome image of plural colors with plural liquid developers corresponding to the plural colors respectively (developing);

transferring the plural monochrome images of the plural colors to a recording medium, thereby forming on the recording medium an unfixed color image containing the plural monochrome images superimposed on each other (transferring); and

irradiating the unfixed color image with an ultraviolet ray, thereby fixing the unfixed color image to the recording medium (fixing),

the liquid developer containing toner particles, an insulating liquid mainly containing an epoxy-modified compound in liquid form, and a cationic photopolymerization initiator.

It is preferred in the image forming method according to the aspect of the invention that the ultraviolet ray, with which the unfixed color image is irradiated, has an irradiation energy of from 25 to 500 mJ/cm², and the recording medium is conveyed at a speed of from 50 to 1,000 mm/sec.

It is preferred in the image forming method according to the aspect of the invention that upon irradiating the unfixed color image with an ultraviolet ray for fixing the unfixed image, the unfixed image is applied with heat and pressure simultaneously.

According to the aspects of the invention, such a liquid developer can be provided that is excellent in long-term dispersion stability of toner particles and is excellent in fixing property of toner particles to a recording medium, and an image forming method using the liquid developer can be provided.

### BRIEF DESCRIPTION OF THE DRAWINGS

The invention will be described with reference to the accompanying drawings, wherein like numbers reference like elements.

FIG. 1 is a schematic illustration showing an example of an image forming apparatus, to which a first embodiment of the image forming method of the invention is applied.

FIG. 2 is an enlarged view showing apart of the image forming apparatus shown in FIG. 1.

FIG. 3 is a schematic cross sectional view showing an example of a state of toner particles in a liquid developer layer on a developing roller.

FIG. 4 is a schematic illustration showing an example of an image forming apparatus, to which a second embodiment of the image forming method of the invention is applied.

### DESCRIPTION OF EXEMPLARY EMBODIMENTS

Preferred embodiments of the invention will be explained below in detail.

### Liquid Developer

A liquid developer according to one embodiment of the invention is explained.

The liquid developer of the embodiment of the invention includes an insulating liquid containing an epoxy-modified compound in liquid form and a cationic photopolymerization initiator, and toner particles dispersed in the insulating liquid and containing a rosin resin;

The constitutional components of the liquid developer according to the embodiment of the invention will be described.

### Toner Particles

The toner particles according to the embodiment of the invention contain a rosin resin. The toner particles in the embodiment contain toner mother particles containing a rosin resin having been surface-modified with a polyalkyleneimine.

### Toner Mother Particles

The toner mother particles contain at least a binder resin (resin material) and a colorant.

### 1. Resin Material (Binder Resin)

The toner mother particles are constituted by a material containing a resin material as a major component.

In the embodiment of the invention, the toner mother particles contain a rosin resin as the resin material.

The rosin resin has high affinity (compatibility) with the insulating liquid described later. Accordingly, toner particles containing the rosin resin exhibit high dispersion stability in the insulating liquid described later.

The rosin resin has a large amount of double bonds in the chemical structure thereof. Accordingly, the rosin resin contained in the toner particles and the epoxy compound described later can be bonded upon fixing, and thus the toner particles are fixed with a sufficient fixing strength along with the epoxy compound to a recording medium by the principle described later.

The rosin resin also has high affinity with the polyalkyleneimine described later, and thus the toner particles can attach (adsorb) the polyalkyleneimine firmly on the surface thereof. The rosin resin is plasticized with the insulating liquid, and thus the portion on the toner particles where the rosin resin exposed can attach (adsorb) the polyalkyleneimine further firmly. As a result, the toner particles can maintain the excellent dispersibility for a prolonged period of time, and the liquid developer has excellent charging property.

The rosin resin is preferably present at least apart of the surface of the toner particles. Accordingly, the toner particles have sufficiently high affinity with the insulating liquid, thereby providing excellent dispersibility of the toner particles with the insulating liquid. In this case, the rosin resin may be present locally on the surface of the toner particles or may be present to cover the surface of the toner particles. In the case where the rosin resin is present to cover the surface of the toner particles, the toner particles have higher affinity with the insulating liquid and can attach (adsorb) a larger amount of the polyalkyleneimine to the vicinity of the surface of the toner particles. Furthermore, the rosin resin in the toner particles can be bonded with high efficiency with the epoxy compound in the insulating liquid, thereby providing particularly excellent fixing strength of the toner particles to a recording medium.

In the case, for example, where the rosin resin is coated on the surface of the recording medium, the toner particles containing the rosin resin has high affinity with the recording medium, whereby the toner particles can be fixed to the recording medium firmly. Examples of this case include such a case that paper is used as the recording medium and the surface thereof is coated with the rosin resin as a sizing agent.

Examples of the rosin resin include a maleic acid-modified rosin resin, a phenol-modified rosin resin, a polyester-modified rosin resin, a fumaric acid-modified rosin resin, ester gum and the like, which may be used solely or in combination of two or more kinds thereof. In the case where at least one selected from a maleic acid-modified rosin resin, a phenol-modified rosin resin and a polyester-modified rosin resin is used, the long-term dispersion stability of the toner particles and the fixing property of the liquid developer can be particularly improved.

The rosin resin preferably has a softening point of from 60 to 190° C., more preferably from 65 to 170° C., and further preferably from 70 to 160° C. When the softening point is in the range, the toner particles attain both high fixing property and high heat resistant storage stability while maintaining the excellent long-term dispersion stability and the excellent charging property thereof.

The rosin resin preferably has a weight average molecular weight of from 500 to 100,000, more preferably from 1,000 to 80,000, and further preferably from 1,000 to 50,000. When the weight average molecular weight is in the range, the toner particles attain both high fixing property and high heat resistant storage stability while maintaining the excellent long-term dispersion stability and the excellent charging property thereof.

The rosin resin preferably has an acid value of 40 mgKOH/g or less, more preferably 30 mgKOH/g or less, and further preferably from 5 to 25 mgKOH/g. When the acid value is in the range, the surface of the toner mother particles can be chemically modified favorably with the polyalkyleneimine, and the toner particles attain both high fixing property and high heat resistant storage stability while maintaining the excellent long-term dispersion stability and the excellent charging property thereof.

The content of the rosin resin in the resin material constituting the toner mother particles is preferably from 1 to 50% by weight, and more preferably from 5 to 40% by weight. When the content of the rosin resin is in the range, the toner particles attain both high fixing property and high heat resistant storage stability while maintaining the excellent long-term dispersion stability and the excellent charging property thereof.

The toner mother particles may contain other known resins than the above-described rosin resin.

In particular, it is preferred to use the above-described rosin resin and a resin material having an ester bond in combination. The resin material having an ester bond has low compatibility with the rosin resin, whereby the rosin resin can be securely present on the surface of the toner particles. As a result, the surface of the toner mother particles can be chemically modified with a larger amount of the polyalkyleneimine, whereby the positive charging property of the toner particles can be further enhanced, and the dispersion stability of the toner particles can also be further enhanced. Furthermore, the liquid developer can be enhanced in high temperature storage stability.

Preferred examples of the resin material having an ester bond include a polyester resin, a styrene-acrylate ester copolymer and a methacrylic resin. Among these, a polyester resin is preferably used. A polyester resin has high transparency, and the use thereof as a binder resin provides an image with high coloring property. A polyester resin has particularly low compatibility with the rosin resin to cause securely phase separation from the rosin resin in the toner mother particles, whereby the rosin resin can be effectively present on the surface of the toner mother particles

In the case where the toner mother particles contain a polyester resin, the polyester resin preferably has an acid value of from 5 to 20 mgKOH/g, and more preferably from 5 to 15 mgKOH/g.

In the case where the toner mother particles contain a polyester resin, the softening point of the polyester resin is not particularly limited and is preferably from 60 to 160° C., more preferably from 60 to 140° C., and further preferably from 60 to 115° C. When the softening point is in the range, the fixing property of the toner particles can be particularly enhanced. The softening point referred herein means such a softening starting temperature that is defined by measuring with a Koka flow tester (produced by Shimadzu Corporation) under measurement conditions of a temperature increasing rate of 5° C. per minute and a die hole diameter of 1.0 mm.

In the case where the toner mother particles contain a resin having an ester bond, the toner mother particles preferably contain two or more kinds of resin components having different weight average molecular weights as the resin having an ester bond. Specifically, the toner mother particles preferably contain, as the resin having an ester bond, a first resin component having a relatively small weight average molecular weight and a second resin component having a larger weight average molecular weight than the first resin component. The use of the plural kinds of resin components in the toner mother particles provides the following advantages.

The first resin component having a relatively small weight average molecular weight can be easily melted at a relatively low temperature. Accordingly, in the case where the first resin component is contained in the toner mother particles, the first resin component can be melted along with the rosin resin at a relatively low fixing temperature (for example, from 100 to 140° C.) upon heating a toner image for fixing, whereby the toner particles are easily softened, thereby being fixed to a recording medium firmly. Furthermore, the toner particles are relatively easily melted, whereby plural kinds of toner particles each containing different colorants are easily melted and mixed upon fixing, thereby providing a toner image excellent in coloring property.

The second resin component having a relatively large weight average molecular weight is hard to melt and soften under a relatively high temperature condition. Accordingly, in the case where the second resin component is contained in the toner mother particles, the toner particles are prevented from being melted or deformed even when the liquid developer is exposed to a relatively high temperature condition (for example, from 40 to 80° C.) upon storing the liquid developer unused in an image forming apparatus or the like. Particularly, in the case where the first resin component or the rosin resin is started to melt under the relatively high temperature condition, the second resin component functions as a skeleton of the toner mother particles. As a result, the plural toner particles in the liquid developer can be securely prevented from being aggregated by adhering them or deformed under a high temperature condition.

Consequently, the liquid developer can be particularly enhanced in fixing property and the long-term dispersion stability of the toner particles by using the first resin component and the second resin component in the toner mother particles in addition to the rosin resin.

The first resin component preferably has a weight average molecular weight of from 3,000 to 12,000, more preferably from 4,000 to 10,000, and further preferably from 5,000 to 7,000. The second resin component preferably has a weight average molecular weight of from 20,000 to 400,000, more preferably from 50,000 to 300,000, and further preferably from 10,000 to 250,000.

The first resin component preferably has a softening temperature Tf of from 60 to 120° C., and more preferably from 80 to 110° C. The second resin component preferably has a softening temperature Tf of from 60 to 220° C., and more preferably from 80 to 190° C.

The amount of the first resin component contained in the resin material constituting the toner mother particles is preferably from 30 to 80% by weight, and more preferably from 40 to 75% by weight. The amount of the second resin component contained in the resin material constituting the toner mother particles is preferably from 5 to 40% by weight, and more preferably from 10 to 30% by weight.

### 2. Colorant

The toner mother particles may contain a colorant. The colorant is not particularly limited, and a dye, a pigment and the like having been known in the art may be used.

### 3. Other Components

The toner mother particles may further contain other components than those described above. Examples of the components include wax and magnetic powder having been known in the art.

Examples of the constitutional material (component) of the toner mother particles further include zinc stearate, zinc oxide, cerium oxide, silica, titanium oxide, iron oxide, a fatty acid and a metallic salt of a fatty acid, in addition to the materials described above.

### Polyalkyleneimine

In this embodiment, the toner mother particles constituted by materials including the rosin resin is surface-modified with a polyalkyleneimine. The surface modification with a polyalkyleneimine herein means that at least a part of the amino groups of the polyalkyleneimine and at least a part of acidic groups (mainly carboxyl groups) derived from the rosin resin on the surface of the toner mother particles undergo chemical reaction to form covalent bonds (amide bonds), or in alternative, the acidic groups of the rosin resin and the amino groups of the polyalkyleneimine undergo ion bonds.

The polyalkyleneimine has a large amount of amino groups and thus is a compound that has high positive charging property. The toner mother particles constituted by materials including the rosin resin is surface-modified with the polyalkyleneimine, whereby the liquid developer can be enhanced in positive charting property and long-term dispersion stability of the toner particles. The liquid developer is excellent in charging property and long-term dispersion stability, thereby being improved particularly in such properties as developing efficiency and transferring efficiency.

The polyalkyleneimine is chemically bonded to the rosin resin of the toner mother particles, as being different from a charge controlling agent and a dispersant having been ordinarily used, and therefore, the polyalkyleneimine stably maintains the positive charging property and the dispersion stability for a prolonged period of time without release or drop off from the toner particles (toner mother particles).

Furthermore, upon reusing the liquid developer recovered in the developing unit or the like in the image forming apparatus described later, the toner particles in the recovered liquid developer can be easily dispersed again, thereby facilitating the reuse thereof.

The aforementioned advantage of the polyalkyleneimine can be obtained by surface-modifying the toner mother particles with the polyalkyleneimine, but cannot be obtained only by simply adding the polyalkyleneimine to a liquid developer.

Examples of the polyalkyleneimine include polyethyleneimine, polypropyleneimine, polybutyleneimine and polyisopropyleneimine, and polyethyleneimine is preferably used. Accordingly, the surface of the toner mother particles can be chemically modified favorably, thereby enhancing the long-term dispersion stability and the positive charging property of the toner particles.

The polyalkyleneimine preferably has a number average molecular weight of from 300 to 200,000, and more preferably from 10,000 to 80,000. When the number average molecular weight of the polyalkyleneimine is in the range, the surface of the toner mother particles can be modified (chemically modified) effectively, and the toner particles can be effectively prevented from being aggregated owing to the steric hindrance of the relatively long molecular chain of the polyalkyleneimine, thereby effectively enhancing the dispersion stability of the toner particles.

### Shape of Toner Particles

The toner particles constituted by the aforementioned materials preferably have an average particle diameter of from 0.5 to 3 μm, more preferably from 1 to 2.5 μm, and more preferably from 1 to 2 μm. When the average particle diameter of the toner particles is in the range, fluctuation in properties among the toner particles can be suppressed, whereby the total reliability of the liquid developer is improved, and a toner image formed by the liquid developer can have a sufficiently high resolution. Furthermore, the toner particles can be improved in dispersibility in an insulating liquid, thereby improving the storage stability of the liquid developer. The term “average particle diameter” referred herein means an average particle diameter based on volume.

The content of the toner particles in the liquid developer is preferably from 10 to 60% by weight, and more preferably from 20 to 50% by weight.

### Insulating Liquid

The insulating liquid will be described below.

The insulating liquid constituting the liquid developer of the embodiment of the invention contains an epoxy-modified compound.

The epoxy-modified compound referred herein means a compound (epoxide) that has a three-membered ring referred to as an epoxy group (oxirane ring) in the molecular structure, which is a compound in a liquid form having high insulating property capable of being used as an insulating liquid of a liquid developer.

In the case where an image is formed with a liquid developer, the insulating liquid is attached to the surface of the toner particles upon fixing the toner particles to a recording medium. A liquid developer having been used in the art has such a problem that the insulating liquid attached to the surface of the toner particles impairs the fixing property of the toner particles to the recording medium (i.e., the fixing strength is lowered). Such a method may be considered that the toner particles are fixed by heating to a relatively high temperature for a prolonged period of time for removing (drying) the insulating liquid completely from the recording medium, thereby improving the fixing strength of the toner particles to the recording medium, but the method cannot attain high-speed image formation, which is demanded in recent years.

On the other hand, the liquid developer of one embodiment of the invention contains the insulating liquid containing the epoxy-modified compound and a cationic photopolymerization initiator in combination, thereby improving the fixing strength of the toner particles to a recording medium.

When a liquid containing the epoxy-modified compound and the cationic photopolymerization initiator is irradiated with an energy ray, such as an ultraviolet ray (UV light) and an electron beam, in general, the cationic photopolymerization initiator is activated to form an hydrogen ion. The hydrogen ion is reacted with the epoxy group of the epoxy-modified compound to proceed curing reaction and polymerization reaction of the epoxy-modified compound, thereby solidifying the liquid. In the embodiment of the invention, the toner particles contain the rosin resin, which contains a large amount of double bonds in the chemical structure thereof. The double bonds can be bonded to the epoxy-modified compound upon curing and polymerization reaction of the epoxy-modified compound, and as a result, the toner particles containing the rosin resin and the cured insulating liquid containing the epoxy-modified compound are firmly bonded to each other.

Accordingly, by radiating an ultraviolet ray or the like to a toner image (liquid developer) transferred to a recording medium, the epoxy-modified compound contained in the toner image is solidified around the toner particles, thereby fixing the toner particles firmly to the recording medium. In the embodiment of the invention, the insulating liquid transferred to a recording medium (for example, the insulating liquid attached to the surface of the toner particles) exhibits a function of fixing the toner particles to the recording medium. Furthermore, the cured insulating liquid and the toner particles (or the constitutional component thereof) are chemically bonded, whereby the toner particles (or the toner image) that has been once fixed to a recording medium is hard to be released off from the recording medium.

The epoxy-modified compound is solidified in a significantly short period of time. Accordingly, the liquid developer of the embodiment of the invention can fix the toner particles to the recording medium in a short period of time, as compared to a known ordinary liquid developer, in which heat energy is applied to an unfixed toner image to fix the toner particles to the recording medium. Accordingly, the liquid developer of the embodiment of the invention is suitably applied to high-speed image formation.

In image formation with an ordinary liquid developer, the insulating liquid is present on an area of the recording medium other than an area where the toner particles are transferred. The insulating liquid is an involatile liquid, and therefore, in continuous image formation, there is a problem of a blocking phenomenon where the printed recording media are adhered to each other. In image formation with the liquid developer of the embodiment of the invention, on the other hand, the insulating liquid constituting the liquid developer is completely solidified on the recording medium upon fixing, and thus the problem can be effectively prevented from occurring.

In image formation with the liquid developer of the embodiment of the invention, furthermore, the toner image can be fixed to the recording medium only by radiating an energy ray to an unfixed toner image on the recording medium. Accordingly, the liquid developer of the embodiment of the invention can achieve energy saving as compared to image formation with an ordinary liquid developer where a toner image is fixed by a heat treatment.

In the liquid developer of the embodiment of the invention, the insulating liquid impregnated into a recording medium, such as paper, is solidified, thereby exhibiting an anchor effect between the solidified insulating liquid and the recording medium. Accordingly, the fixing strength of the toner particles to the recording medium is enhanced thereby.

In image formation with the liquid developer of the embodiment of the invention, the fixing strength of the toner particles can be relatively improved to a recording medium that does not absorb the insulating liquid, such as a vinyl chloride film and a polypropylene film, in addition to a recording medium that absorbs the insulating liquid, such paper.

In this embodiment, the toner particles contain the toner mother particles having been surface-modified with the polyalkyleneimine. The use of the toner particles makes the effect of the epoxy-modified compound significant. It is considered that this is because a large amount of amino groups contained in the chemical structure of the polyalkyleneimine involve the curing reaction of the epoxy-modified compound.

In the embodiment of the invention, accordingly, the insulating liquid contains the epoxy-modified compound, and the toner particles contain the rosin resin, thereby achieving excellent fixing property and excellent long-term dispersion stability. In the case where the toner particles do not contain the rosin resin, on the other hand, the epoxy-modified compound to be cured and the toner particles are not sufficiently adhered to fail to provide an excellent fixing strength, and it is difficult to disperse the toner particles stably in the insulating liquid for a prolonged period of time. In the case where the insulating liquid does not contain the epoxy-modified compound, the insulating liquid impairs the toner particles from being fixed to the recording medium, as described above, and thus the fixing property is deteriorated.

Examples of the epoxy-modified compound include an epoxide obtained by modifying a carbon-carbon double bond (C═C) contained in a vegetable oil, a mineral oil or the like to an epoxy group, and an epoxy-modified silicone oil obtained by replacing at least a part of methyl groups of a silicone oil by epoxy group-containing alkyl groups, which may be used solely or in combination of two or more kinds thereof.

Among these, an epoxidized vegetable oil contains a large amount of epoxy group since a vegetable oil to be epoxidized contains a large amount of carbon-carbon double bonds in the structure thereof, and thus undergoes curing reaction and polymerization reaction favorably with a hydrogen ion. Accordingly, the use of the epoxidized vegetable oil as the epoxy-modified compound enhances the fixing strength of the toner particles to the recording medium. The epoxidized vegetable oil has excellent compatibility with the rosin resin, and thus the dispersibility of the toner particles in the liquid developer is further enhanced to provide the liquid developer that has excellent storage stability.

A vegetable oil generally contains as a major component a fatty acid triglyceride, which is a triester between a fatty acid and glycerin (triglyceride), and contains an unsaturated fatty acid (i.e., a fatty acid having a carbon-carbon double bond in the main chain thereof) as the fatty acid component.

The vegetable oil used for providing the epoxidized vegetable oil preferably contains an unsaturated fatty acid component having two or more carbon-carbon double bonds as a constitutional component. The epoxidized vegetable oil obtained by modifying the vegetable oil is solidified in a short period of time and provides sufficiently high hardness after solidification.

Examples of the vegetable oil to be epoxy-modified for providing the epoxidized vegetable oil include a drying oil, such as dehydrated caster oil, wood oil, linseed oil, sunflower oil, rose hip oil and perilla oil, and a semi drying oil, such as soybean oil, canola oil, safflower oil, cotton seed oil, sesame seed oil and corn oil.

Among these vegetable oils, linseed oil and soybean oil are preferably used. In other words, epoxidized linseed oil obtained by epoxidizing linseed oil and epoxidized soybean oil obtained by epoxidizing soybean oil are preferred as the epoxidized vegetable oil. This is because linseed oil and soybean oil as the starting materials contain a relatively large amount of carbon-carbon double bonds in the structure thereof. Accordingly, epoxidized linseed oil and epoxidized soybean oil obtained by epoxidizing these oils as the starting materials favorably undergo curing reaction and polymerization reaction with a hydrogen ion generated from the cationic photopolymerization initiator described later.

The vegetable oil preferably has an iodine value of from 70 to 220, and more preferably from 80 to 200. The vegetable oil satisfying the condition contains a large amount of carbon-carbon double bonds in the molecular structure thereof, and the epoxidized vegetable oil obtained by epoxidizing the vegetable oil has a large amount of epoxy groups (oxirane rings) in the molecular structure thereof.

The epoxidized vegetable oil preferably has an iodine value of 15 or less, and more preferably 10 or less. The epoxidized vegetable oil is solidified in a shorter period of time upon fixing, and exhibits a sufficiently high hardness after solidification.

The epoxidized vegetable oil preferably satisfies the relationship, 0≦I₁/I₂≦0.17, and more preferably 0.01≦I₁/I₂≦0.11, wherein I₁ represents the iodine value of the epoxidized vegetable oil, and I₂ represents the iodine value of the vegetable oil before being epoxy-modified. The epoxidized vegetable oil satisfying the relationship has a sufficiently high content of epoxy groups in the molecular structure thereof, is solidified in a shorter period of time upon fixing, and exhibits a sufficiently high hardness after solidification.

The insulating liquid may contain other components than the epoxy-modified compound.

Examples of the components include Isoper E, Isoper G, Isoper H and Isoper L (produced by Exxon Mobile Corporation), Shellsol 70 and Shellsol 71 (produced by Shell Chemicals, Ltd.) Amsco OMS and Amsco 460 (produced by American Mineral Spirits Co.), a mineral oil (a liquid hydrocarbon), such as low-viscosity and high-viscosity liquid paraffin (produced by Wako Pure Chemical Industries, Ltd.), a fatty acid glyceride, a vegetable oil containing a medium chain fatty acid ester, a fatty acid monoester, which is an ester between a fatty acid and a monohydric alcohol, octane, isooctane, decane, isodecane, decalin, nonane, dodecane, isododecane, cyclohexane, cyclooctane, cyclodecane, benzene, toluene, xylene, and mesitylene.

The insulating liquid preferably contains a fatty acid monoester among these materials. The fatty acid monoester easily penetrates into the molecular chains of the resin material constituting the toner particles, and the fatty acid monoester having been entrained into the resin material exhibits a plasticizing function of plasticizing the toner particles (resin material). The toner particles are thus plasticized, whereby the rosin resin in the toner particles is easily made in contact with the insulating liquid, and thus the epoxy-modified compound and the rosin resin are easily bonded upon fixing. As a result, the liquid developer that contains the fatty acid monoester has excellent fixing property. In the case where a toner image is applied with heat upon fixing, the toner particles plasticized with the fatty acid monoester are easily melted at a relatively low temperature and thus fixed to the recording medium. The plasticized toner particles can be fixed to the recording medium further firmly, and the resulting toner image exhibits an excellent fixing strength.

The fatty acid monoester is a naturally derived material, and is an environmentally benign material. Accordingly, the load on the environments caused by leakage of the insulating liquid outside an image forming apparatus and disposal of the used liquid developer can be reduced. As a result, an environmentally benign liquid developer can be provided.

The fatty acid component constituting the fatty acid monoester is represented by the general formula, R—COOH (wherein R represents an alkyl group) and is not particularly limited, and examples thereof include an unsaturated fatty acid, such as oleic acid, palmitoleic acid, linoleic acid, α-linolenic acid, γ-linolenic acid, arachidonic acid, docosahexaenoic acid (DHA) and eicosapentaenoic acid (EPA), and a saturated fatty acid, such as butyric acid, lauric acid, caproic acid, caprylic acid, capric acid, myristic acid, palmitic acid, stearic acid, arachidinic acid, behenic acid and lignoceric acid, which may be used solely or in combination of two or more kinds of them.

Among these, in the case where the fatty acid monoester contains a saturated fatty acid as the fatty acid component, the fatty acid monoester is difficult to suffer deterioration (such as oxidation and decomposition), i.e., chemically stable.

In the case where the fatty acid monoester contains a saturated fatty acid as the fatty acid component, the fatty acid monoester preferably contains a fatty acid having from 8 to 20 carbon atoms. When the fatty acid monoester is used, the plasticizing effect of the fatty acid monoester to the toner particles is favorably exhibited.

The fatty acid monoester is an ester of a fatty acid and a monohydric alcohol, and the alcohol preferably has from 1 to 4 carbon atoms. In this case, the liquid developer has excellent chemical stability, and the insulating liquid has a suitable viscosity, which facilitates penetration of the liquid developer to the recording medium. Examples of the alcohol include methanol, ethanol, propanol, butanol and isobutanol.

The fatty acid monoester may be formed by ester exchange reaction between a vegetable oil and the monohydric alcohol. In other words, the insulating liquid used in this embodiment of the invention may contain a fatty acid monoester obtained by combining one kind or two or more kinds selected from the fatty acids and the alcohols described above.

Examples of the vegetable oil subjected to the ester exchange reaction include soybean oil, canola oil, dehydrated caster oil, wood oil, safflower oil, linseed oil, sunflower oil, corn oil, cotton seed oil, sesame seed oil, hemp oil, evening primrose oil, palm oil (particularly palm kernel oil) and coconut oil.

The content of the fatty acid monoester in the insulating liquid is preferably from 5 to 50% by weight, more preferably from 10 to 45% by weight, and further preferably from 15 to 45% by weight. When the content of the fatty acid monoester is in the range, the toner particles are favorably plasticized.

In the case where the insulating liquid contains other components than the epoxy-modified compound, the content of the epoxy-modified compound in the insulating liquid is preferably 50% by weight or more, and more preferably 60% by weight or more. When the content of the epoxy-modified compound is in the range, an image can be formed at a sufficiently high speed, and the toner particles can be fixed to the recording medium with an excellent fixing strength.

The insulating liquid preferably has an electric resistance of 10¹¹ Ωcm or more, 10¹² Ωcm or more, and further preferably 10¹³ Ωcm or more, at room temperature (20° C.)

The insulating liquid preferably has a relative permeability of 3.5 or less.

The viscosity of the insulating liquid is not particularly limited, and is preferably from 5 to 1,000 mPa·s, more preferably from 50 to 800 mPa·s, and further preferably from 50 to 500 mPa·s. When the insulating liquid has a viscosity within the range, a suitable amount of the insulating liquid is attached to the toner particles upon taking up the liquid developer from a liquid developer container to an application rollers whereby an image can be formed at a high speed, and the toner image can be fixed to the recording medium with an excellent fixing property. The viscosity referred herein is a value measured at 25° C.

### Cationic Photopolymerization Initiator

The cationic photopolymerization initiator will be described.

The liquid developer of the embodiment of the invention contains a cationic photopolymerization initiator.

The cationic photopolymerization initiator is a compound that is activated to generate a hydrogen ion upon irradiation with an energy ray, such as an ultraviolet ray, and has a function of causing curing reaction and polymerization reaction of the epoxy-modified compound constituting the insulating liquid.

In the case where the cationic photopolymerization initiator is contained in the liquid developer, an unfixed toner image (liquid developer) having been transferred to a recording medium is irradiated with an energy ray, such as an ultraviolet ray, whereby the insulating liquid is quickly solidified to fix the toner particles firmly to the recording medium.

Examples of the cationic photopolymerization initiator include an onium salt, such as a diazonium salt, a sulfonium salt, an iodonium salt and a phosphonium salt, having as a counter ion an anion, such as a halide anion, a sulfonate anion, a carboxylate anion and a sulfate anion.

Among these, an aromatic sulfonium salt and an aromatic iodonium salt having an aromatic ring in the molecular structure thereof are preferably used. The cationic photopolymerization initiator is a chemically stable compound and is hard to form a hydrogen ion with other energy than an energy ray (for example, heat energy). Accordingly, the liquid developer can be securely prevented from being polymerized by activating the cationic photopolymerization initiator to cure the epoxy-modified compound upon storing. Therefore, the liquid developer containing the cationic photopolymerization initiator has excellent storage stability for a prolonged period of time, and can fix the toner particles to a recording medium by solidifying the insulating liquid quickly upon fixing.

The cationic photopolymerization initiator has high solubility in the epoxy-modified compound and is hard to deposit in the liquid developer. Accordingly, such a problem can be securely prevented from occurring that the cationic photopolymerization initiator is deposited in the liquid developer under storing to deteriorate the storage stability of the toner particles. The cationic photopolymerization initiator can be dispersed homogeneously in the liquid developer, whereby the insulating liquid can be quickly solidified upon irradiating the unfixed toner image (liquid developer) with an energy ray, and the fixing strength of the toner particles to the recording medium is free of unevenness.

The content of the cationic photopolymerization initiator in the liquid developer is preferably from 0.5 to 8 parts by weight, and more preferably from 2 to 5 parts by weight, per 100 parts by weight of the epoxy-modified compound constituting the insulating liquid.

### Sensitizer

The liquid developer preferably contains a sensitizer. The sensitizer absorbs an energy ray having a specific wavelength range in the ultraviolet region, and transfers the energy thus absorbed to the cationic photopolymerization initiator. The sensitizer contained in the liquid developer absorbs the energy ray in such a wavelength range that is not absorbed by the cationic photopolymerization initiator, and the energy of the energy ray thus absorbed by the sensitizer is transferred from the sensitizer to the cationic photopolymerization initiator. As a result, the energy ray with a broader range of wavelength can be effectively used as energy for polymerization reaction of the epoxy-modified compound.

The sensitizer that can be used in the liquid developer is not particularly limited, and examples thereof include an acridine compound, a benzoflavin compound, a perylene compound, a naphthalene compound, an anthracene compound, a thioxanthone compound and a laser dye, which may be used solely or in combination of two or more kinds thereof.

Among these, at least one of a naphthalene compound, an anthracene compound and a thioxanthone compound is preferably used as the sensitizer, and an anthracene compound is more preferably used. In this case, the energy of the energy ray can be efficiently used as energy for polymerization reaction of the epoxy-modified compound. In particular, the use of 9,10-dibutoxyanthracene among the anthracene compound as the sensitizer exhibits these advantages conspicuously.

The content of the sensitizer in the liquid developer is preferably from 20 to 300 parts by weight, and more preferably from 30 to 200 parts by weight, per 100 parts by weight of the cationic photopolymerization initiator.

### Dispersant

The liquid developer may contain a dispersant.

The dispersant contributes to the dispersion stability of the toner particles.

The dispersant that can be used in the liquid developer of the embodiment of the invention is not particularly limited, and known dispersants may be used.

Preferred examples of the dispersant include a polymer dispersant having a 12-hydroxystearic acid skeleton in the molecule. The dispersant having the skeleton has high compatibility with the insulating liquid (particularly, the vegetable oil and the fatty acid monoester) and can be dissolved favorably in the insulating liquid. The 12-hydroxystearic acid skeleton moiety has high affinity with the resin material constituting the toner particles, and thus the dispersant can be attached favorably to the surface of the toner particles. Upon attaching the dispersant to the surface of the toner particles, the amount of the dispersant that is free in the insulating liquid is decreased, thereby maintaining the high insulating property of the insulating liquid. As a result, the dispersion stability of the toner particles can be enhanced, and the charging property of the liquid developer can be enhanced.

The polymer dispersant having the skeleton has a long molecular chain, which has high possibility of being in contact with the surface of the toner particles, and thus can be firmly attached or adsorbed to the surface of the toner particles. As a result, the dispersion stability of the toner particles can be enhanced.

Examples of the dispersant having the skeleton include Solsperse 11200 and Solsperse 13940 (a trade name, available from Lubrizol Corporation).

The content of the dispersant in the liquid developer is preferably from 1 to 7 parts by weight, and more preferably from 1.25 to 5 parts by weight, per 100 parts by weight of the toner particles. When the content of the dispersant is in the range, the dispersion stability of the toner particles can be effectively enhanced, and the positive charging property of the liquid developer can be further enhanced.

### Production Method of Liquid Developer

Preferred embodiments of a production method of the liquid developer of the embodiment of the invention will be described.

The production method of the liquid developer according to the embodiment includes: preparation of a dispersion liquid, in which a dispersion liquid having toner mother particles containing a rosin resin dispersed in an aqueous dispersion medium is prepared; chemical modification, in which a polyalkyleneimine is mixed with the dispersion liquid to modify the surface of the toner mother particles with the polyalkyleneimine, thereby providing toner particles; and dispersion in an insulating liquid, in which the toner particles are dispersed in an insulating liquid.

The procedures constituting the production method of the liquid developer will be described.

### Preparation of Dispersion Liquid (Preparation of Aqueous Dispersion Liquid)

A dispersion liquid having toner mother particles containing a rosin resin dispersed in an aqueous dispersion medium (aqueous dispersion liquid) is prepared.

The aqueous dispersion liquid may be prepared in any method, and is preferably prepared as a suspension liquid through such procedures that includes: preparation of a resin solution, in which a resin solution containing the constitutional material of the toner mother particles, such as the rosin resin, (mother particle materials) dissolved in an organic solvent is prepared; preparation of an O/W emulsion liquid, in which an aqueous liquid is added to the resin solution, whereby an O/W emulsion liquid is prepared through a W/O emulsion liquid; integration, in which the dispersoid contained in the O/W emulsion liquid is integrated to form integrated particles; and removal of the organic solvent, in which the organic solvent contained in the integrated particles is removed to form the toner mother particles. Accordingly, the homogeneity in size and shape of the dispersoid contained in the aqueous dispersion liquid can be further enhanced, whereby a significantly sharp particle size distribution is obtained for the toner particles contained in the liquid developer finally obtained, and fluctuation in properties among the toner particles can be suppressed. In the following description, such a case will be described, for example, that the aqueous dispersion liquid is prepared through the preparation of a resin solution, the preparation of an O/W emulsion liquid; the integration; and the removal of an organic solvent.

### Preparation of Resin Solution

A resin solution containing the rosin resin dissolved in an organic solvent is prepared.

The resin solution thus prepared contains the constitutional components of the toner mother particles described above, and an organic solvent described later.

The organic solvent may be any one that dissolves at least a part of the resin material, and an organic solvent that has a lower boiling point that an aqueous liquid described later is preferably used. In this case, the organic solvent can be easily removed.

The organic solvent preferably has low compatibility with the aqueous liquid (aqueous dispersion medium) described later (for example, an organic solvent having a solubility of 30 g or less in 100 g of the aqueous liquid at 25° C.). In this case, the dispersoid constituted by the mother particle materials can be finely dispersed in a stable state in the O/W emulsion liquid (aqueous emulsion liquid) described later.

The composition of the organic solvent may be appropriately selected depending, for example, on the composition of the resin material, the composition of the colorant and the composition of the aqueous liquid (aqueous dispersion medium).

The organic solvent is not particularly limited, and examples thereof include a ketone solvent, such as methyl ethyl ketone (MEK), and an aromatic hydrocarbon solvent, such as toluene.

The resin solution can be obtained, for example, by mixing the resin material, the colorant, the organic solvent and the like in an agitator or the like. Examples of the agitator that can be used for preparing the resin solution include a high-speed mixing machine, such as DESPA (produced by Asada Iron Works Co., Ltd.), and T. K. Robomix and T. K. Homodisper 2.5 type blade (produced by Primix Corporation)

The temperature of the materials upon mixing is preferably from 20 to 60° C., and more preferably from 30 to 50° C.

The solid content in the resin solution is not particularly limited, and is preferably from 40 to 75% byweight, more preferably from 50 to 73% by weight, and further preferably from 50 to 70% by weight. When the solid content is in the range, the dispersoid constituting the dispersion liquid (aqueous dispersion liquid) described later can have a high sphericity (i.e., a shape close to a true sphere), and the shape of the toner particles finally obtained can be favorably improved.

Upon preparation of the resin solution, all the constitutional components of the resin solution to be prepared may be simultaneously mixed, or in alternative, only a part of the constitutional components of the resin solution to be prepared may be mixed to form a mixture (master) in advance, and then the mixture (master) is mixed with the other components.

### Preparation of O/W Emulsion Liquid

An aqueous liquid is added to the resin solution to prepare an O/W emulsion liquid through a W/O emulsion liquid.

The aqueous liquid may contain water as a major component.

The aqueous liquid may contain a solvent that has high compatibility with water (for example, a solvent having a solubility of 50 parts by weight or more in 100 parts by weight of water at 25° C.).

The aqueous liquid may contain an emulsification dispersant depending on necessity. The addition of the emulsification dispersant facilitates preparation of the aqueous emulsion liquid. The emulsification dispersant is not particularly limited, and a known emulsification dispersant may be used.

Upon preparation of the O/W emulsion liquid, for example, a basic substance may be used. When the basic substance is used, the functional group (such as a carboxyl group) contained in the resin material can be neutralized, thereby improving the homogeneity in shape and size of the dispersoid and the dispersibility of the dispersoid in the O/W emulsion liquid. Accordingly, the toner particles thus obtained has a particularly sharp particle size distribution. The basic substance may be added, for example, to the resin solution or to the aqueous liquid. The basic substance may be added plural times during the preparation of the O/W emulsion liquid.

Examples of the basic substance include sodium hydroxide, potassium hydroxide and ammonia, which may be used solely or in combination of two or more kinds thereof.

The amount of the basic substance used is preferably an amount corresponding to from 1 to 3 times the amount necessary for neutralizing the entire carboxyl groups contained in the resin material (i.e., from 1 to 3 equivalents), and more preferably an amount corresponding to from 1 to 2 times (i.e., from 1 to 2 equivalent). When the amount of the basic substance is in the range, a dispersoid with an irregular form can be effectively prevented from being formed, and a sharp particle size distribution can be obtained for particles obtained in the integration described later.

The aqueous liquid maybe added to the resin solution in any method, and the aqueous liquid containing water is preferably added to the resin solution under stirring the resin solution. Specifically, it is preferred that the aqueous liquid is gradually added (added dropwise) to the resin solution while applying a shearing force to the resin solution with an agitator or the like, whereby a W/O type emulsion liquid (W/O emulsion liquid) is phase-transferred to an O/W type emulsion liquid (O/W emulsion liquid). In this case, the homogeneity in size and shape of the dispersoid contained in the O/W emulsion liquid can be particularly enhanced, and a sharp particle size distribution can be obtained for the toner particles contained in the liquid developer finally obtained, whereby fluctuation in properties among the toner particles can be suppressed.

Examples of the agitator that can be used for preparing the O/W emulsion liquid include a high-speed mixing machine, such as DESPA (produced by Asada Iron Works Co. Ltd.), T. K. Robomix and T. K. Homodisper 2.5 type blade (produced by Primix Corporation), Slasher (produced by Mitsui Mining Co., Ltd.) and Cavitron (produced by Eurotec, Ltd.), and a high-speed dispersing machine.

Upon adding the aqueous liquid to the resin solution, the resin solution is preferably stirred at a blade tip velocity of from 10 to 20 m/sec, and more preferably from 12 to 18 m/sec. When the blade tip velocity is in the range, the O/W emulsion liquid can be efficiently obtained, and the fluctuation in shape and size of the dispersoid in the O/W emulsion liquid can be decreased, whereby the homogeneous dispersion property of the dispersoid can be enhanced while preventing excessively small particles and coarse particles of the dispersoid from being formed.

The solid content in the O/W emulsion liquid is not particularly limited, and is preferably from 5 to 55% by weight and more preferably from 10 to 50% by weight. When the solid content is in the range, the productivity of the liquid developer can be enhanced while unintended aggregation of the dispersoid in the O/W emulsion liquid from occurring.

The temperature of the materials in the procedures is preferably from 20 to 60° C., and more preferably from 20 to 50° C.

### Integration

Plural pieces of the dispersoid are then integrated to form integrated particles. The integration of the dispersoid generally proceeds in such a manner that the pieces of the dispersoid containing the organic solvent collide with each other and are integrated to each other.

The integration of the plural pieces of the dispersoid is performed by adding an electrolyte to the O/W emulsion liquid while the O/W emulsion liquid is stirred. According to the procedures, the integrated particles can be easily and securely produced. The particle diameter and the particle size distribution of the integrated particles can be easily and securely controlled by adjusting the amount of the electrolyte added.

The electrolyte is not particularly limited, and known organic or inorganic water-soluble salts and the like may be used solely or in combination of two or more kinds thereof.

The electrolyte is preferably a salt of a monovalent cation. The use of a salt of a monovalent cation makes the particle size distribution of the integrated particles sharp. The use of a salt of a monovalent cation can prevent coarse particles from being formed in this procedure.

The electrolyte is more preferably a sulfate salt (such as sodium sulfate and ammonium sulfate) or a carbonate salt, and is particularly preferably a sulfate salt. The particle diameter of the integrated particles can be easily controlled by using a sulfate salt or a carbonate salt.

The amount of the electrolyte added in this procedure is preferably from 0.5 to 3 parts by weight, and more preferably from 1 to 2 parts by weight, per 100 parts by weight of the solid content of the O/W emulsion liquid, to which the electrolyte is added. When the amount of the electrolyte is in the range, the particle diameter of the integrated particles can be easily and securely controlled, and coarse particles can be securely prevented from being formed.

The electrolyte is preferably added in the form of an aqueous solution. In the case where the electrolyte is added as an aqueous solution, the electrolyte can be quickly dispersed over the entire O/W emulsion liquid, and the amount of the electrolyte added can be easily and securely controlled. Consequently, integrated particles that have an intended particle diameter and a sharp particle size distribution can be obtained.

In the case where the electrolyte is added in the form of an aqueous solution, the concentration of the electrolyte in the aqueous solution is preferably from 2 to 10% by weight, and more preferably from 2.5 to 6% by weight. When the concentration of the electrolyte is in the range, the electrolyte can be dispersed more quickly over the entire O/W emulsion liquid, and the amount of the electrolyte added can be more securely controlled. Furthermore, when the aqueous solution is added, the content of water in the O/W emulsion liquid can be a favorable value after completing the addition of the electrolyte. Accordingly, the growing rate of the integrated particles after completing the addition of the electrolyte can be appropriately lowered in such an extent that the productivity is not impaired. Consequently, the particle diameter of the integrated particles can be further securely controlled, and unintended integration of the integrated particles can be securely prevented from occurring.

Upon adding the electrolyte in the form of an aqueous solution, the rate of addition of the electrolyte aqueous solution is preferably from 0.5 to 10 parts by weight per minute, and more preferably from 1.5 to S parts by weight per minute, per 100 parts by weight of the solid content contained in the O/W emulsion liquid, to which the electrolyte aqueous solution is added. When the rate of addition is in the range, the concentration of the electrolyte in the O/W emulsion liquid can be prevented from suffering unevenness, whereby coarse particles can be securely prevented from being formed, and the particle size distribution of the integrated particles can be sharp. The addition of the electrolyte at a rate within the range facilitates control of the rate of integration, whereby the average particle diameter of the integrated particles can be easily controlled, and the productivity of the liquid developer can be particularly enhanced.

The electrolyte may be added plural times. By adding the electrolyte plural times, the integrated particles that have an intended size can be easily and securely obtained, and the sphericity of the integrated particles obtained can be sufficiently large.

The electrolyte may be added under stirring the O/W emulsion liquid, whereby such integrated particles can be obtained that are considerably small in fluctuation of shape and size among the particles.

The O/W emulsion liquid can be stirred by using such a stirring blade as an anchor blade, a turbine blade, a Faudler blade, a full-zone blade, a max blend blade and a half-moon blade, and among these a max blend blade and a full-zone blade are preferably used. By using the blades, the electrolyte added can be dispersed and dissolved quickly and uniformly, thereby preventing securely unevenness in concentration of the electrolyte from occurring, and the integrated particles once formed can be prevented from being broken while integrating the dispersoid efficiently. As a result, the integrated particles that are small in fluctuation in shape and particle diameter among the particles can be efficiently produced.

The blade tip velocity of the mixing blade is preferably from 0.1 to 10 m/sec, more preferably from 0.2 to 8 m/sec, and further preferably from 0.2 to 6 m/sec. When the blade tip velocity is in the range, the electrolyte added can be uniformly dispersed and dissolved, whereby unevenness in concentration of the electrolyte can be securely prevented from occurring, and the integrated particles once formed can be prevented from being broken while integrating the dispersoid efficiently.

The resulting integrated particles preferably have an average particle diameter of from 0.5 to 5 μm, and more preferably from 1.5 to 3 μm. In the case where the particle diameter is in the range, the particle diameter of the toner particles finally obtained can be controlled securely to an intended value.

### Removal of Organic Solvent

Thereafter, the organic solvent contained in the O/W emulsion liquid (particularly in the dispersoid) is removed. By removing the organic solvent, a dispersion liquid (aqueous dispersion liquid) having the toner mother particles dispersed in the aqueous dispersion medium can be obtained.

The organic solvent may be removed in any method, and can be removed, for example, by reducing the pressure. By the procedure, the organic solvent can be efficiently removed while preventing the constitutional materials, such as the resin material, from denaturing.

The temperature in this procedure is preferably a temperature that is lower than the glass transition point (Tg) of the resin material constituting the integrated particles.

This procedure may be performed in the state that a defoaming agent is added to the O/W emulsion liquid (dispersion liquid), whereby the organic solvent can be efficiently removed.

Examples of the defoaming agent include a mineral defoaming agent, a polyether defoaming agent and a silicone defoaming agent, and also include a lower alcohol, a higher alcohol, a fat, a fatty acid, a fatty acid ester and a phosphate ester.

The amount of the defoaming agent used is not particularly limited, and is preferably from 20 to 300 ppm by weight, and more preferably from 30 to 100 ppm by weight, based on the solid content in the O/W emulsion liquid.

In this procedure, at least a part of the aqueous liquid may be removed along with the organic solvent.

In this procedure, it is not necessary to remove the entire organic solvent (i.e., the total amount of the organic solvent contained in the dispersion liquid). Even when the entire organic solvent is not removed, the organic solvent remaining can be sufficiently removed in the later process described later.

### Rinsing (First Rinsing)

The toner mother particles thus obtained are then rinsed. By rinsing the toner mother particles, a dispersion liquid (aqueous dispersion liquid) containing the rinsed toner mother particles can be obtained.

By rinsing the toner mother particles, the organic solvent or the like contained as impurities if any can be efficiently removed. By rinsing the toner mother particles, furthermore, the electrolyte, the basic substance and the acidic substance used in the preceding process and a salt formed through the acid-base reaction can be efficiently removed. As a result, the amount of the total volatile organic compounds (TVOC) in the toner particles finally obtained can be particularly decreased. Furthermore, the electric resistance of the insulating liquid can be particularly increased, and the stability of the properties of the toner particles can be enhanced.

The rinsing can be performed, for example, in such a manner that the toner mother particles are separated from the aqueous liquid by solid-liquid separation, and the solid component (toner mother particles) is again dispersed (re-dispersion) in an aqueous liquid (aqueous dispersion medium). The solid-liquid separation and the re-dispersion may be performed repeatedly plural times. The toner mother particles are preferably rinsed until the electroconductivity of the supernatant of the dispersion liquid (slurry) having the solid component (toner mother particles) re-dispersed in the aqueous liquid (aqueous dispersion medium) reaches 20 μS/cm or less.

### Surface Modification

The dispersion liquid (aqueous dispersion liquid) containing the toner mother particles is then mixed with a polyalkyleneimine to surface-modify the toner mother particles with the polyalkyleneimine.

The surface modification may be performed by mixing the aqueous dispersion liquid and the polyalkyleneimine, and is preferably performed in the state where the hydrogen ion exponent (pH) of the dispersion liquid (aqueous dispersion liquid) is adjusted to a range of from 2 to 8. By adjusting the pH to the range, the acidic groups present on the surface of the toner mother particles constituted by the material containing the rosin resin can be efficiently reacted with the polyalkyleneimine while preventing securely unintended denaturation of the constitutional materials of the toner mother particles from occurring, and thus the polyalkyleneimine can be firmly fixed to the surface of the toner mother particles. Consequently, the toner particles can be particularly enhanced in long-term dispersion stability and stability in charging property. The hydrogen ion exponent (pH) of the dispersion liquid (aqueous dispersion liquid) in this procedure is preferably from 2 to 8 as described above, and is more preferably from 2.5 to 6.5, and further preferably from 4 to 5. When the pH is in the range, the aforementioned advantages can be further conspicuously exhibited.

The pH can be adjusted, for example, by adding IN hydrochloric acid or the like to the dispersion liquid.

After mixing the dispersion liquid and the polyalkyleneimine, the mixture is preferably stirred for about from 1 to 3 hours. By stirring the mixture, the surface of the toner mother particles can be uniformly modified (chemically modified).

The mixture may be stirred at ordinary temperature, or may be stirred under heating the mixture to about from 30 to 40° C. By heating the mixture during stirring the surface of the toner mother particles can be efficiently modified (chemically modified).

The amount of the polyalkyleneimine used in the surface modification is preferably from 0.1 to 10 parts by weight, more preferably from 0.3 to 6.0 parts by weight, and further preferably from 0.5 to 3.0 parts by weight, per 100 parts by weight of the amount of the rosin resin. When the amount of the polyalkyleneimine used is in the range, the long-term dispersion stability and the positive charging property of the toner particles can be particularly enhanced while preventing securely such a problem as elution of the excessive polyalkyleneimine into the insulating liquid from occurring in the liquid developer finally obtained.

### Rinsing (Second Rinsing)

The toner particles thus obtained are then rinsed.

By rinsing the toner particles, the polyalkyleneimine unreacted, the organic solvent and the like remaining as impurities if any can be efficiently removed. As a result, the amount of the total volatile organic compounds (TVOC) in the toner particles finally obtained can be particularly decreased, and the stability in properties of the toner particles is also improved.

The polyalkyleneimine is firmly fixed to the toner mother particles containing the rosin resin as described above. Accordingly, the polyalkyleneimine can be securely prevented from being desorbed or released from the toner mother particles even when the toner particles are rinsed, as being different from a dispersant and the like having been ordinarily used in a liquid developer.

The rinsing can be performed, for example, in such a manner that the toner particles are separated from the aqueous liquid by solid-liquid separation, the solid component (toner particles) is again dispersed (re-dispersion) in an aqueous liquid (aqueous dispersion medium) and the toner particles are separated from the aqueous liquid by solid-liquid separation. The solid-liquid separation and the re-dispersion of the solid content may be performed repeatedly plural times.

### Drying

Thereafter, the toner particles can be obtained by drying. By drying the toner particles, the water content in the toner particles can be securely lowered sufficiently, and the properties, such as the storage stability and the stability in properties, of the toner finally obtained can be particularly enhanced.

The toner particles can be dried, for example, by using a vacuum dryer (such as Ribocorn (produced by Okawara Corporation) and Nauta (produced by Hosokawa Micron Co., Ltd.) ), a fluidized bed dryer (produced by Okawara Corporation), and the like. In this embodiment, the toner particles are constituted by materials containing the rosin resin, and therefore, the toner particles can be securely prevented from being aggregated even when the toner particles are dried.

### Dispersion in Insulating Liquid

The toner particles thus obtained are then dispersed in the insulating liquid, thereby providing a liquid developer. In the embodiment of the invention, the insulating liquid contains the epoxy-modified compound. Upon dispersing the toner particles in the insulating liquid, the cationic photopolymerization initiator is dispersed or dissolved in the insulating liquid.

The toner particles may be dispersed in the insulating liquid in any method, and for example, in such a manner that the insulating liquid and the toner particles are mixed with a beads mill, a ball mill or the like.

Upon dispersing the toner particles, other components than the insulate in liquid and the toner particles may also be mixed.

The dispersion of the toner particles in the insulating liquid may be performed by using the entire amount of the insulating liquid constituting the liquid developer finally obtained, or may be performed by using a part of the insulating liquid.

In the case where the toner particles are dispersed in a part of the insulating liquid, the same liquid as the insulating liquid used for dispersing may be added as the insulating liquid after dispersing, or a liquid different from the insulating liquid used for dispersing may be added as the insulating liquid after dispersing. In the later case, the properties, such as the viscosity, of the liquid developer finally obtained can be easily controlled.

Upon dispersing, other components than the insulating liquid, the toner particles and the cationic photopolymerization initiator may be mixed.

In the case where the liquid developer is produced in the aforementioned method, the toner particles contained therein contain the constitutional materials dispersed homogeneously, and suffer less fluctuation in shape among the toner particles. Accordingly, fluctuation in surface area among the particles is prevented from occurring.

### Image Forming Method and Image Forming Apparatus

### First Embodiment

A first embodiment of the image forming method will be described.

The image forming method of this embodiment forms a color image (toner image) on a recording medium by using the liquid developer of the aforementioned embodiment of the invention.

More specifically, the image forming method of the embodiment contains: forming plural monochrome image of plural colors with plural kinds of the liquid developers corresponding to the plural colors respectively (developing); transferring the plural monochrome images of the plural colors to a recording medium, thereby forming on the recording medium an unfixed toner image containing the plural monochrome images superimposed on each other (transferring) ; and irradiating the unfixed toner image with an ultraviolet ray, thereby fixing the unfixed toner image to the recording medium (fixing).

The image forming method of the embodiment will be described with reference to a specific example of an image forming apparatus.

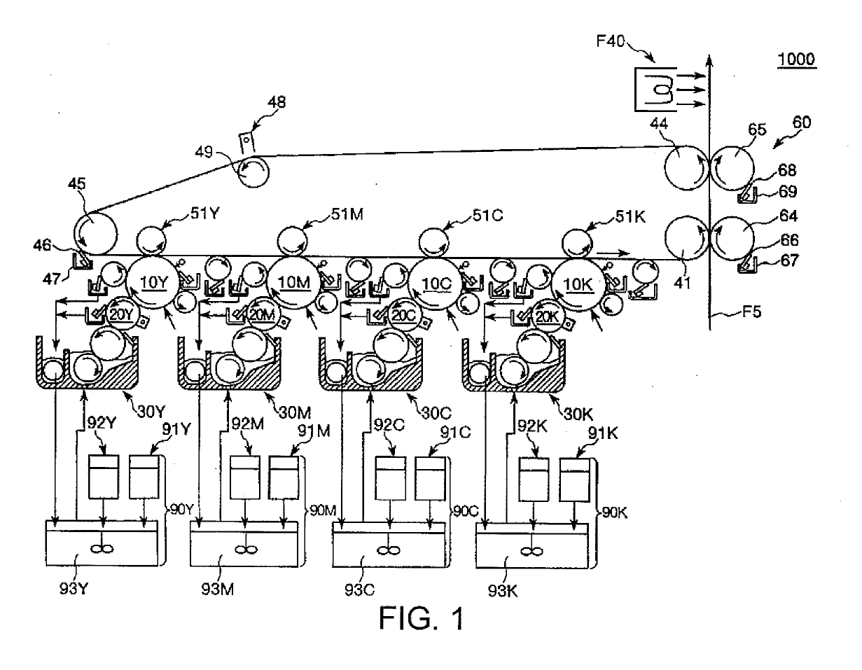

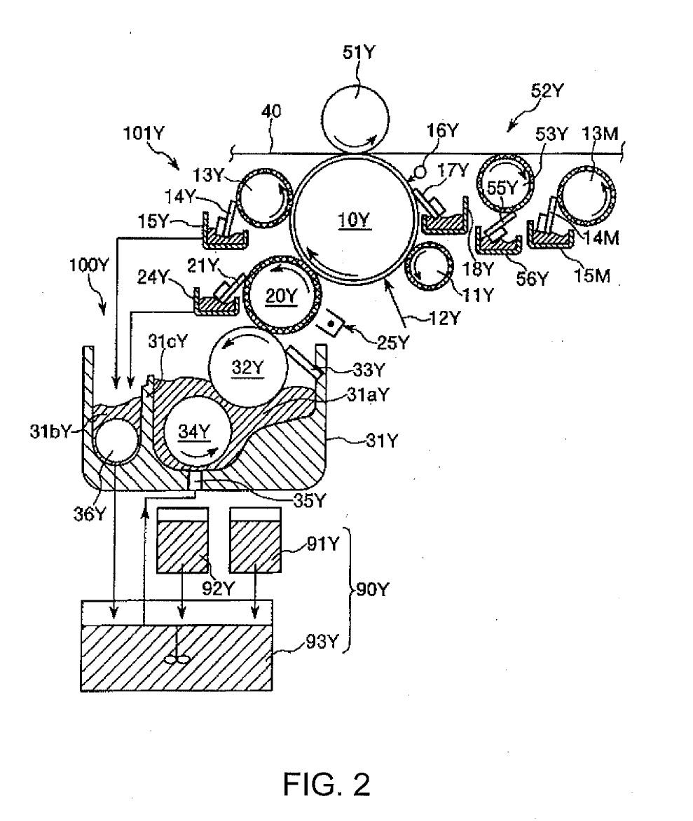

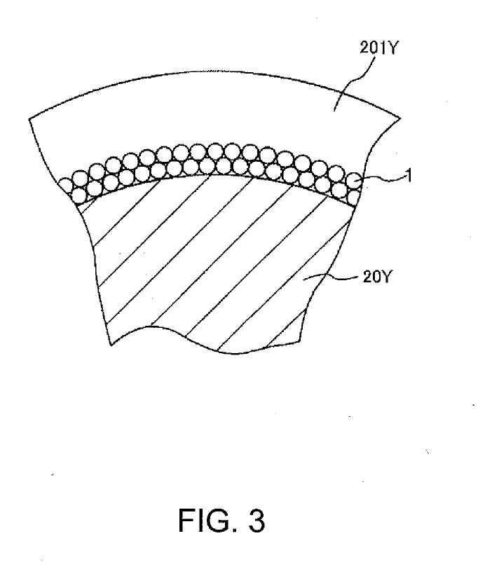

FIG. 1 is a schematic illustration showing an example of an image forming apparatus, to which the first embodiment of the image forming method of the invention is applied. FIG. 2 is an enlarged view showing a part of the image forming apparatus shown in FIG. 1. FIG. 3 is a schematic cross sectional view showing an example of a state of toner particles in a liquid developer layer on a developing roller.

The image forming apparatus 1000 has, as shown in FIGS. 1 and 2, four developing devices 30Y, 30M, 30C and 30K, an intermediate transferring part 40, a secondary transferring unit (secondary transferring device) 60, an ultraviolet ray radiating device (fixing device) F40, and four liquid developer feeding devices 90Y, 90M, 90C and 90K.

The developing devices 30Y, 30M and 30C each develop latent images with a yellow liquid developer (Y), a magenta liquid developer (M) and a cyan liquid developer (C), respectively, thereby forming color monochrome images corresponding to the colors. The developing device 30K develops a latent image with a black liquid developer (K), thereby forming a black monochrome image.

The developing devices 30Y, 30M, 30C and 30K have the same structure, and the developing device 30Y is described below.

The developing device 30Y has, as shown in FIG. 2, a photoreceptor 10Y as an example of an image holding member, and has, along the rotation direction of the photoreceptor 10Y, a charging roller 11Y, an exposing unit 12Y, a developing unit 100Y, a photoreceptor squeezing device 11Y, a primary transfer backup roller 51Y, a destaticizing unit 16Y, a photoreceptor cleaning blade 17Y and a developer recovering device 18Y.

The photoreceptor 10Y has a cylindrical substrate and a photosensitive layer constituted, for example, by amorphous silicon or the like, formed on an outer circumference surface thereof. The photoreceptor 10Y is rotatable around the center axis, and in the embodiment, is rotatable in the clockwise direction shown by the arrow in FIG. 2.

A liquid developer is fed to the photoreceptor 10Y from the developing unit 100Y described later, thereby forming a layer of the liquid developer on the surface thereof. In other words, a monochrome image is formed on the surface of the photoreceptor 10Y (developing).

The charging roller 11Y charges the photoreceptor 10Y, and the exposing unit 12Y radiates laser light onto the charged photoreceptor 10Y, thereby forming a latent image thereon. The exposing unit 12Y has a semiconductor laser, a polygonal mirror, an F-θ lens and the like, and radiates laser light, which is modulated based on an image signal input from a host computer, such as a personal computer, a word processor, not shown in the figure, onto the charged photoreceptor 10Y.

The developing unit 100Y develops the latent image formed on the photoreceptor 10Y with the liquid developer according to the embodiment of the invention. The developing unit 100Y will be described in detail later.

The photoreceptor squeezing device 101Y is disposed on the downstream side of the developing unit 100Y in the rotation direction of the photoreceptor 10Y and faces the photoreceptor 10Y, and has a photoreceptor squeezing roller 13Y, a cleaning blade 14Y pressed onto the squeezing roller 13Y for removing the liquid developer attached thereto, and a developer recovering device 15Y recovering the liquid developer thus removed. The photoreceptor squeezing device 101Y recovers the excessive carrier (insulating liquid) and the unnecessary fogged toner from the developer developed on the photoreceptor 10Yi thereby increasing the ratio of the toner particles in the developed image.

The primary transfer backup roller 51Y transfers the monochrome image formed on the photoreceptor 10Y to the intermediate transferring part 40.

The destaticizing unit 16Y removes the remaining charge on the photoreceptor 10Y after transferring the intermediate transferred image to the intermediate transferring part 40 with the primary transfer backup roller 51Y.

The photoreceptor cleaning blade 17Y is a rubber member that is pressed onto the surface of the photoreceptor 10Y, and scrapes and removes the liquid developer remaining on the photoreceptor 10Y after transferring the intermediate transferred image to the intermediate transferring part 40 with the primary transfer backup roller 51Y.

The developer recovering device 18Y recovers the liquid developer having been removed with the photoreceptor cleaning blade 17Y.

The intermediate transferring part 40 is an endless elastic belt member and stretched on a belt driving roller 41, which is driven with a motor not shown in the figure, and a pair of driven rollers 44 and 45. The intermediate transferring part 40 is rotated in an anticlockwise direction with the belt driving roller 41 while being in contact with the photoreceptors 10Y, 10m, 10C and 10K with the primary backup rollers 51Y, 51M, 51C and 51K.

The intermediate transferring part 40 is applied with a prescribed tension with a tension roller 49 to prevent slack. The tension roller 49 is disposed on the downstream side of one of the driven rollers 44 in the rotation (moving) direction of the intermediate transferring part 40 and on the upstream side of the other driven roller 45 in the rotation (moving) direction of the intermediate transferring part 40.

The monochrome images corresponding to the colors formed in the developing devices 30Y, 30M, 30C and 30K are transferred sequentially to the intermediate transferring part 40 with the primary transfer backup rollers 51Y, 51M, 51C and 51K, thereby superimposing the monochrome images corresponding to the colors. Consequently, a full color developer image (intermediate transferred image) is formed on the intermediate transferring part 40 (intermediate transferring).

The intermediate transferring part 40 holds the monochrome images formed on the plural photoreceptors 10Y, 10M, 10C and 10K sequentially secondary-transferred and superimposed on each other, and secondary-transfers them at a time to a recording medium F5, such as paper, a film and a cloth, in the secondary transferring device 60 described later. Upon transferring the toner images to the recording medium F5 in secondary transferring, there are cases where the recording medium F5 is a sheet member that has a non-smooth surface owing to fiber materials or the like. Accordingly, an elastic belt member is used as intermediate transferring part 40, whereby the toner images can be transferred with good secondary transferring property by allowing the intermediate transferring part 40 to follow the non-smooth surface.

The intermediate transferring part 40 has a cleaning device containing an intermediate transferring part cleaning blade 46, a developer recovering device 47 and a non-contact bias applying device 48.

The intermediate transferring part cleaning blade 46 and the developer recovering device 47 are disposed on the side of the driven roller 45.

The intermediate transferring part cleaning blade 46 scrapes and removes the liquid developer attached to the intermediate transferring part 40 after transferring the images to the recording medium F5 with the secondary transferring unit (secondary transferring device) 60.

The developer recovering device 47 recovers the liquid developer having been removed by the intermediate transferring part cleaning blade 46.

The non-contact bias applying device 48 is disposed at a position facing the tension roller 49 with a distance to the intermediate transferring part 40. The non-contact bias applying device 48 applies a bias voltage, which has the reverse polarity to the toner (solid content) of the liquid developer remaining on the intermediate transferring part 40 after secondary transferring, to the toner. According to the procedure, the toner is destaticized to decrease the electrostatic attaching force of the toner to the intermediate transferring part 40. In this embodiment, a corona discharging device is used as the non-contact bias applying device 48.

The non-contact bias applying device 48 may not be disposed at the position facing the tension roller 49, and may be disposed at a position on the downstream side of the driven roller 44 in the moving direction of the intermediate transferring part and on the upstream side of the driven roller 45 in the moving direction of the intermediate transferring part, for example, at a position between the driven roller 44 or 45 and the tension roller 49. The non-contact bias applying device 48 may be a known non-contact charging device other than a corona discharging device.

An intermediate transferring part squeezing device 52Y is disposed on the downstream side of the primary transfer backup roller 51Y in the moving direction of the intermediate transferring part 40.

In the case where the liquid developer transferred to the intermediate transferring part 40 is not in a favorable dispersed state, the intermediate transferring part squeezing device 52Y removes the excessive insulating liquid from the liquid developer having been transferred.

The intermediate transferring part squeezing device 52Y is constituted by an intermediate transferring part squeezing roller 53Y, an intermediate transferring part squeezing cleaning blade 55Y pressed onto the intermediate transferring part squeezing roller 53Y to clean the surface thereof, and a developer recovering device 56Y recovering the liquid developer having been removed by the intermediate transferring part squeezing cleaning blade 55Y.

The intermediate transferring part squeezing device 52Y recovers the excessive insulating liquid from the developer primarily transferred to the intermediate transferring part 40, whereby the ratio of the toner particles in the images is increased, and the unnecessary fogged toner is recovered.

The secondary transferring unit 60 has a pair of secondary transferring rollers disposed along the moving direction of the transferring material with a prescribed distance. Among the secondary transferring rollers, the secondary transferring roller that is disposed on the upstream side in the moving direction of the intermediate transferring part 40 is referred to as an upstream side secondary transferring roller 64. The upstream side secondary transferring roller 64 can be pressed onto the belt driving roller 41 through the intermediate transferring part 40.

Among the pair of secondary transferring rollers, the secondary transferring roller that is disposed on the downstream side in the moving direction of the transferring material is referred to as a downstream side secondary transferring roller 65. The downstream side secondary transferring roller 65 can be pressed onto the driven roller 44 through the intermediate transferring part 40.

Accordingly, the upstream side secondary transferring roller 64 and the downstream side secondary transferring roller 65 allow the recording medium F5 to be in contact with the intermediate transferring part 40, which is stretched on the belt driving roller 41 and the driven roller 44, whereby the intermediate transferred image obtained by superimposing the color images on the intermediate transferring part 40 is secondarily transferred to the recording medium F5 (secondary transferring).

In this case., the belt driving roller 41 and the driven roller 44 also function as backup rollers for the upstream side secondary transferring roller 64 and the downstream side secondary transferring roller 65, respectively. The belt driving roller 41 also functions as an upstream side backup roller disposed on the upstream side of the driven roller 44 in the moving direction of the recording medium F5 in the secondary transferring unit 60. The driven roller 44 also functions as a downstream side backup roller disposed on the downstream side of the belt driving roller 41 in the moving direction of the recording medium F5 in the secondary transferring unit 60.

Accordingly, the recording medium F5 fed to the secondary transferring unit 60 is in close contact with the intermediate transferring part 40 in the prescribed moving area of from the press-starting position between the upstream side secondary transferring roller 64 and the belt driving roller 41 (nip-starting position) to the press-end position between the downstream side secondary transferring roller 65 and the driven roller 44 (nip-end position). According to the procedures, the full color intermediate transferred image on the intermediate transferring part 40 is secondarily transferred to the recording medium F5, which is in close contact with the intermediate transferring part 40, over a prescribed period of time, thereby performing the secondary transferring favorably.

The secondary transferring unit 60 has a secondary transferring roller cleaning blade 66 and a developer recovering device 67 for the upstream side secondary transferring roller 64. The secondary transferring unit 60 has a secondary transferring roller cleaning blade 68 and a developer recovering device 69 for the downstream side secondary transferring roller 65. The secondary transferring roller cleaning blades 66 and 68 are in contact with the secondary transferring rollers 64 and 65, respectively, thereby scraping and removing the liquid developer remaining on the surfaces of the secondary transferring rollers 64 and 65 after secondary transferring. The developer recovering devices 67 and 69 recover and store the liquid developer having been scraped off from the secondary transferring rollers 64 and 65 with the secondary transferring roller cleaning blades 66 and 68.

The toner image (transferred image) F5a transferred to the recording medium F5 with the secondary transferring unit 60 is conveyed to the ultraviolet ray radiating device (fixing device) F40 and fixed (fixing).

The ultraviolet ray radiating device F40 radiates an ultraviolet ray onto the surface of the recording medium F5 having been conveyed, on which the toner image F5a is formed. By radiating an ultraviolet ray onto the toner image F5a from the ultraviolet ray radiating device F40, the insulating liquid constituting the toner image F5a is solidified. Accordingly, the toner particles are fixed firmly to the recording medium, thereby providing an excellent fixing strength for the toner image F5a to the recording medium F5. One of the advantages of the embodiment of the invention is attained by the procedure for fixing.

By irradiating the liquid developer of the embodiment of the invention with an energy ray, such as an ultraviolet ray, the cationic photopolymerization initiator is activated, and the insulating liquid quickly solidified while fixing the toner particles. Accordingly, the period of time required for fixing can be largely reduced as compared to heat fixing ordinarily employed, in which toner particles are melted by heat and fixed to a recording medium. As a result, the printing speed can be easily increased. Furthermore, no large quantity of heat is required for fixing the toner image F5a to the recording medium F5, thereby attaining energy saving.

In the image forming method of the embodiment of the invention, the toner image F5a can be fixed to the recording medium F5 in a non-contact mode, in which the toner image F5a is not in contact with any member. By employing the non-contact mode, the resulting toner image F5a is sharp without blur as compared to the case where a toner image is fixed to a recording medium in a contact mode (for example, a heated roller is pressed onto a toner image for fixing).

The radiation energy of the ultraviolet ray radiated from the ultraviolet ray radiating device F40 is preferably from 25 to 500 mJ/cm², and more preferably from 40 to 500 mJ/cm². When the radiation energy is in the range, the cationic photopolymerization initiator contained in the liquid developer is securely activated, thereby causing the curing reaction and polymerization reaction of the epoxy-modified compound more efficiently. As a result, the toner image F5a can be fixed further firmly to the recording medium F5 in a shorter period of time.

The conveying speed of the recording medium F5 (i.e., the toner image F5a) in the ultraviolet ray radiating device F40 is preferably from 50 to 1,000 mm/sec, and more preferably from 200 to 700 mm/sec. In the image formation using the liquid developer according to the embodiment of the invention, the toner image F5a can be fixed firmly to the recording medium F5 with the conveying speed in the aforementioned range.

A unit for applying heat and pressure to the toner image F5a fixed in the ultraviolet ray radiating device F40 may be provided. By providing the unit for applying heat and pressure, the fixing strength of the toner image F5a to the recording medium F5 can be further enhanced.

In the case where the toner image F5a is heated, the heating temperature is preferably from 70 to 160° C., more preferably from 100 to 150° C., and further preferably from 100 to 140° C.

The developing units 100Y, 100M, 100C and 100K will be described in detail. In the following description, the developing unit 100Y will be described as a representative.

The developing unit 100Y has, as shown in FIG. 2, a liquid developer storing part 31Y, a coating roller 32Y, a restricting blade 33Y, a developer agitating roller 34Y, a connecting part 35Y, a recovering screw 36Y, a developing roller 20Y, a developing roller cleaning blade 21Y and a corona discharging device (compressing device) 25Y.

The liquid developer storing part 31Y stores the liquid developer for developing the latent image formed on the photoreceptor 10Y, and has a feeding part 31aY for feeding the liquid developer to the developing device, a recovering part 31bY for recovering the excessive liquid developer generated in the feeding part 31aY and the like, and a partition 31cY separating the feeding part 31aY and the recovering part 31bY.

The feeding part 31aY feeds the liquid developer to the coating roller 32Y, and has a depressed portion, in which the developer agitating roller 34Y is provided. The liquid developer is fed to the feeding part 31aY from the liquid developer storing part 31Y through the connecting part 35Y.

The recovering part 31bY recovers the liquid developer that is excessively fed to the feeding part 31aY and the excessive liquid developer generated in developer recovering devices 15Y and 24Y. The liquid developer thus recovered is conveyed to a liquid developer mixing bath 93Y described later and reused. The recovering part 31bY has a depressed portion, in which the recovering screw 36Y is provided.

The partition 31cY in the form of a wall is provided at the boundary between the feeding part 31aY and the recovering part 31bY. The partition 31cY separates the feeding part 31aY and the recovering part 31bY and prevents the recovered liquid developer from being mixed in the fresh liquid developer. In the case where an excessive amount of the liquid developer is fed to the feeding part 31aY, the excessive liquid developer can spill out from the feeding part 31aY to the recovering part 31bY over the partition 31cY. Accordingly, the amount of the liquid developer in the feeding part 31aY can be maintained to a constant amount, and the amount of the liquid developer that is fed to the coating roller 32Y can also be maintained to a constant amount. Consequently, the quality of the image finally obtained can be maintained stably.

The partition 31cY has a notch, through which the liquid developer can spill out from the feeding part 31aY to the recovering part 31bY.

The coating roller 32Y feeds the liquid developer to the developing roller 20Y.

The coating roller 32Y is a so-called an anilox roller, which is a nickel-plated metallic roller, such as iron, having on the surface thereof grooves formed homogeneously in a spiral form, and has a diameter of approximately 25 mm. In this embodiment, plural grooves are formed in an oblique direction with respect to the rotation direction of the coating roller 32Y by cutting process, rolling process or the like. The coating roller 32Y is in contact with the liquid developer while rotating in the anticlockwise direction, whereby the liquid developer in the feeding part 31aY is held in the grooves and conveys the held liquid developer to the developing roller 20Y.

The restricting blade 33y is in contact with the surface of the coating roller 32Y, thereby restricting the amount of the liquid developer on the coating roller 32Y. Specifically, the restricting blade 33Y scrapes the excessive liquid developer on the coating roller 32Y, thereby metering the liquid developer on the coating roller 32Y, which is fed to the developing roller 20Y. The restricting blade 33Y is formed of urethane rubber as an elastic material, and is supported by a restricting blade supporting member formed of a metal, such as iron. The restricting blade 33Y is provided on the side where the rotating coating roller 32Y comes out from the liquid developer (i.e., on the right side in FIG. 2). The restricting blade 33Y has a rubber hardness of approximately 77 in terms of JIS-A, and thus the hardness of the part of the restricting blade 33Y in contact with the surface of the coating roller 32Y (approximately 77) is lower than the hardness of the elastic material layer of the developing roller 20Y in contact with the surface of the coating roller 32Y (approximately 85). The excessive liquid developer thus scraped is recovered to the feeding part 31aY and reused.

The developer agitating roller 34Y agitates the liquid developer to make a homogeneous dispersed state, and even in the case where plural toner particles 1 are aggregated, the toner particles 1 can be favorably dispersed by the developer agitating roller 34Y.

In the feeding part, 31aY, the toner particles 1 in the liquid developer have positive charge, and the liquid developer is in a homogeneous dispersed state through agitation with the developer agitating roller 34Y. The liquid developer is taken out from the liquid developer storing part 31Y through rotation of the coating roller 32Y, and the liquid developer is fed to the developing roller 20Y after restricting the amount of the liquid developer by the restricting blade 33Y. The liquid developer is agitated with the developer agitating roller 34Y, whereby the liquid developer can be stably spilled out to the recovering part 31bY over the partition 31cY, thereby preventing the liquid developer from being accumulated and compressed.

The developer agitating roller 34Y is provided in the vicinity of the connecting part 35Y. Accordingly, the liquid developer fed from the connecting part 35Y can be quickly diffused, and even in the state where the liquid developer is fed to the feeding part 31aY, the liquid surface of the feeding part 31aY can be stabilized. By providing the developer agitating roller 34Y in the vicinity of the connecting part 35Y, the connecting part 35Y is in a negative pressure, thereby aspirating the liquid developer naturally

The connecting part 35Y is provided vertically under the developer agitating roller 34Y to connect to the liquid developer storing part 31Y, and the liquid developer is aspirated from the liquid developer mixing bath 93Y to the feeding part 31aY.

By providing the connecting part 35Y under the developer agitating roller 34Y, the liquid developer fed from the connecting part 35Y is stopped by the developer agitating roller 34Y, and thus the liquid surface of the feeding part 31aY is substantially maintained constant without bulge of the liquid surface due to blow-off of the liquid developer from the connecting part 35Y, thereby feeding the liquid developer stably to the coating roller 32Y.

The recovering screw 36Y provided in the vicinity of the bottom portion of the recovering part 31bY is a cylindrical member having spiral ribs on the outer circumferential surface thereof, and the recovering screw 36Y maintains the flowability of the recovered liquid developer and accelerates to convey the liquid developer to the liquid developer mixing bath 93Y.

The developing roller 20Y holds the liquid developer and conveys the liquid developer to the position facing the photoreceptor 10Y for developing the latent image held by the photoreceptor 10Y with the liquid developer.

The liquid developer is fed from the coating roller 32Y to the surface of the developing roller 20Y to form a liquid developer layer 201Y.

The developing roller 20Y has a core formed of a metal, such as iron, having on an outer circumferential surface thereof an electroconductive elastic layer, and has a diameter of approximately 20 mm. The elastic layer has a two-layer structure, in which the inner layer is a urethane rubber layer having a rubber hardness of approximately 30 in terms of JIS-A and a thickness of approximately 5 mm, and the surface layer (outer layer) is a urethane rubber layer having a rubber hardness of approximately 85 in terms of JIS-A and a thickness of approximately 30 μm. The surface layer of the developing roller 20Y constitutes a contact surface, which is in contact in an elastically deformed state with the coating roller 32Y and the photoreceptor 10Y.

The developing roller 20Y is rotatable around the center axis, and the center axis is positioned under the rotation center axis of the photoreceptor 10Y. The developing roller 20Y is rotated in the reverse direction (the anticlockwise direction in FIG. 2) to the rotation direction of the photoreceptor 10Y (the clockwise direction in FIG. 2). Upon developing the latent image formed on the photoreceptor 10Y, an electric field is formed between the developing roller 20Y and the photoreceptor 10Y.

The corona discharging device (compressing device) 25Y makes the toner of the liquid developer held by the developing roller 20Y in a compressed state. In other words, the corona discharging device 25Y applies the electric field having the same polarity as the toner particles 1 to the liquid developer layer 201Y, thereby locating the toner particles 1 to the vicinity of the surface of the developing roller 20Y in the liquid developer layer 201Y as shown in FIG. 3. By localizing the toner particles, the developing density (developing efficiency) can be increased, thereby providing a sharp image with good quality.

In the developing unit 100Y, the coating roller 32Y and the developing roller 20Y are separately driven by different driving sources, which are not shown in the figure. The rotation speeds (linear velocities) of the coating roller 32Y and the developing roller 20Y are differentiated from each other, thereby controlling the amount of the liquid developer fed onto the developing roller 20Y.

The developing unit 100Y has a developing roller cleaning blade 21Y made of rubber in contact with the surface of the developing roller 20Y and a developer recovering device 24Y. The developing roller cleaning blade 21Y scrapes and removes the liquid developer remaining on the developing roller 20Y after performing development at the developing position. The liquid developer thus removed by the developing roller cleaning blade 21Y is recovered to the developer recovering device 24Y.

As shown in FIGS. 1 and 2, the image forming apparatus 1000 has liquid developer feeding devices 90Y, 90M, 90C and 90K each feeding the liquid developers to the developing devices 30Y, 30M, 30C and 30K, respectively. The liquid developer feeding devices 90Y, 90M, 90C and 90K each have liquid developer tanks 9Y, 91M, 91C and 91K, insulating liquid tanks 92Y, 92M, 92C and 92K, and liquid developer mixing baths 93Y, 93M, 93C and 93K.

The liquid developer tanks 91Y, 91M, 91C and 91K each house the liquid developers corresponding to the colors having a high concentration. The insulating liquid tanks 92Y, 92M, 92C and 92K each house the insulating liquids. To each of the liquid developer mixing baths 93Y, 93M, 93C and 93K, prescribed amounts of the high-concentration liquid developers from the liquid developer tanks 91Y, 91M, 91C and 91K are fed, respectively, and prescribed amounts of the insulating liquids are fed from the insulating liquid tanks 92Y, 92M, 92C and 92K, respectively.

The liquid developer mixing baths 93Y, 93M, 93C and 93K each mix the high-concentration liquid developers and the insulating liquids with the agitating devices each provided therein to produce the liquid developers corresponding to the colors that are used in the feeding parts 31aY, 31aM, 31aC and 31aK. The liquid developers thus produced in the liquid developer mixing baths 93Y, 93M, 93C and 93K each are fed to the feeding parts 31aY, 31aM, 31aC and 31aK, respectively.

The liquid developer recovered by the recovering part 31bY is recovered to the liquid developer mixing bath 93Y and reused. The same operation is performed in each of the liquid developer mixing baths 93M, 93C and 93K.

Image formation by using the aforementioned image forming apparatus is performed by a method containing: forming plural monochrome image of plural colors with plural liquid developers corresponding to the plural colors respectively on the photoreceptors 10 (10Y, 10M, 10C and 10K) (developing); transferring the plural monochrome images of the plural colors formed on the photoreceptors 10 to a recording medium F5, thereby forming on the recording medium F5 an unfixed toner image F5a containing the plural monochrome images superimposed on each other (transferring); and irradiating the unfixed toner image F5a with an ultraviolet ray, thereby fixing the unfixed toner image F5a to the recording medium F5 (fixing). According to the method performed, the toner image F5a can be fixed quickly to the recording medium F5, and as a result, high-speed image formation can be achieved.

### Second Embodiment

A second embodiment of the image forming method will be described.

The image forming method of the second embodiment is different from the image forming method of the first embodiment in such a point that in the fixing procedure, an unfixed toner image is subjected to a heat treatment and then irradiated with an ultraviolet ray, thereby fixing the toner image to the recording medium.

The image forming method of the second embodiment will be described with reference to a specific example of an image forming apparatus.

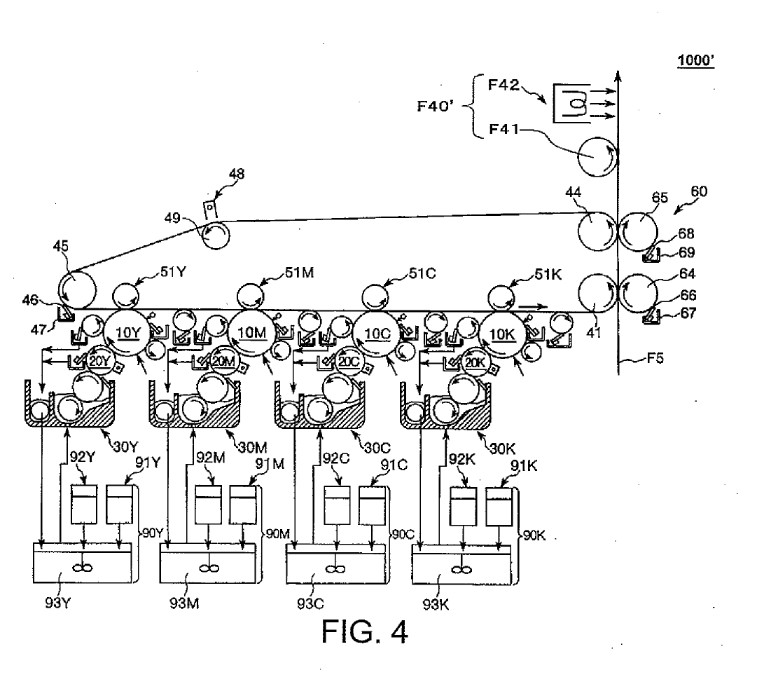

FIG. 4 is a schematic illustration showing an example of an image forming apparatus, to which the second embodiment of the image forming method of the invention is applied.

The image forming apparatus 1000′ shown in FIG. 4 has the same structure as the image forming apparatus 1000 except for using a fixing device F40′ that has a heating roller (heating unit) F41 and an ultraviolet ray radiating device F42.

The heating roller (heating unit) F41 constituting the fixing device F40 of the embodiment is disposed between the secondary transferring unit 60 and the ultraviolet ray radiating device F42. The heating roller F41 is rotated in the anticlockwise direction shown by the arrow in FIG. 4, and heats the unfixed toner image F5a having been transferred to the recording medium F5, which is in contact with the heating roller F41 while being conveyed toward the ultraviolet ray radiating device F42.

The ultraviolet ray radiating device F42 has the same structure as the ultraviolet ray radiating device F40 described for the first embodiment, and thus the description thereof is omitted herein.

In the image forming method using the image forming apparatus 1000′, the toner image F5a transferred to the recording medium F5 with the secondary transferring unit 60 is heated by the heating roller F41 and is then irradiated with an ultraviolet ray by the ultraviolet ray radiating device F42, thereby being fixed to the recording medium F5. In the image forming method, the toner image F5a is heated by the heating roller F41, and thus the toner particles constituting the toner image F5a are melted. The toner image F5a is then irradiated with an ultraviolet ray by the ultraviolet ray radiating device F42 for solidifying the insulating liquid, upon which the toner particles in a molten state are fixed firmly to the recording medium F5. Since the toner particles are in a molten state upon fixing the toner particles to the recording medium F5, the toner particles adjacent to each other are mixed to provide excellent coloring property for the toner image F5a. The molten toner particles enter the surface part of the recording medium F5, such as paper, thereby enhancing the adhesion property between the recording medium F5 and the toner particles. Consequently, the fixing strength of the toner image F5a is particularly enhanced.

The heating temperature upon heating the recording medium F5 having transferred thereon the toner image F5a with the heating roller F41 is preferably from 70 to 160° C., more preferably from 100 to 150° C., and further preferably from 100 to 140° C.

A roller type member is described for the heating device in the embodiment, but the heating device is not limited thereto, and for example, such a method may be employed that the toner image is blown with hot air.

The invention have been described with reference to the preferred embodiments, but the invention is not limited thereto.

For example, the liquid developer of the invention is not limited to those applied to the image forming methods and the image forming apparatuses described above.

The image forming method of the invention is not limited to those applied to the image forming apparatuses described above.

The liquid developer of the invention is not limited to those produced by the production methods described above.

In the aforementioned embodiments, an aqueous emulsion liquid is obtained, and an electrolyte is added to the aqueous emulsion liquid to provide integrated particles, but the invention is not limited to the embodiments. For example, integrated particles may be produced in such a emulsion polymerization association method that a colorant, a monomer, a surfactant and a polymerization initiator are dispersed in an aqueous liquid and subjected to emulsion polymerization to prepare an aqueous emulsion liquid, and an electrolyte is added to the aqueous emulsion liquid to perform association, or may be produced in such a manner that the resulting aqueous emulsion liquid is spray-dried to provide the integrated particles.

In the aforementioned embodiments, the image forming apparatuses have a corona discharging device, but the corona discharging device may not be used.

### EXAMPLES

### (1) Production of Liquid Developer

Before performing examples, toner particles A to J used for producing liquid developers were produced. The processes described with no indication of temperatures were performed at room temperature (25° C.).

### Production of Toner Particles A

### Preparation of Dispersion Liquid (Preparation of Aqueous Dispersion Liquid)

### Preparation of Colorant Master Solution

60 parts by weight of a polyester resin L (weight average molecular weight Mw: 5,200, glass transition temperature: 46° C., softening temperature: 95° C., acid value: 10.0 mgKOH/g) was prepared as a resin material.

A mixture of the resin material and a cyan pigment (Pigment Blue 15:3, produced by Dainichiseika Color & Chemicals Mfg. Co., Ltd.) as a colorant (mass ratio: 50/50) was prepared. The components were mixed with a 20-L Henschel mixer to provide a raw material for producing a toner.

The raw material (mixture) was kneaded with a twin-screw kneading and extruding machine. The kneaded product extruded from the extrusion port of the twin-screw kneading and extruding machine was cooled.

The kneaded product thus cooled was coarsely pulverized to provide a colorant master batch having an average particle diameter of 1.0 mm or less. The kneaded product was coarsely pulverized with a hammer mill.

### Preparation of Resin Solution

97.5 parts by weight of the colorant master batch was mixed with 175 parts by weight of methyl ethyl ketone, 117.0 parts by weight of the polyester resin L, 55.3 parts by weight of a polyester resin H (weight average molecular weight Mw: 237,000, glass transition temperature: 63° C., softening temperature: 182° C., acid value: 9.8 mgKOH/g) and 55.3 parts by weight of a phenol-modified rosin resin (“Tamanol 145”, a trade name, produced by Arakawa Chemical Industries, Ltd., acid value: 18 mgKOH/g or less, softening point: 140 to 155° C., weight average molecular weight: 10,000 to 20,000) with a high-speed dispersing machine (T. K. Robomix and T. K. Homodisper 2.5 type blade, produced by Primix Corporation), to which 1.38 parts by weight of Neogen SC-F, produced by Daiichi Kogyo Seiyaku Co., Ltd. as an emulsifier was added to produce a resin solution. The pigment was homogeneously dispersed in the solution.

### Preparation of O/W Emulsion Liquid

72.8 parts by weight of 1N aqueous ammonia was added to the resin solution in a vessel, and the mixture was sufficiently agitated with a high-speed dispersing machine (T. K. Robomix and T. K. Homodisper 2.5 type blade, produced by Primix Corporation) at a blade tip velocity of 7.5 m/sec. The solution in the vessel was adjusted to 25° C., to which 400 parts by weight or deionized water was then added dropwise while agitating the mixture at a blade tip velocity of 14.7 m/sec, and then 100 parts by weight of deionized water was further added thereto under continuous agitation, thereby providing an O/W emulsion liquid having a dispersoid containing the resin material dispersed therein through a W/O emulsion liquid.

### Integration

The W/O emulsion liquid was placed in an agitation vessel having a max blend blade, and the temperature of the W/O emulsion liquid was controlled to 25° C. under stirring at a blade tip velocity of the stirring blade adjusted to 1.0 m/sec. 200 parts by weight of a 5.0% sodium sulfate aqueous solution was added dropwise to the emulsion liquid while maintaining the temperature and the agitation conditions, thereby performing integration of the dispersoid to form integrated particles. After completing the dropwise addition, the emulsion liquid was continuously agitated until the 50% volume average particle diameter Dv(50) (μm) of the integrated particles reached 2.5 μm. After the Dv(50) of the integrated particles reached 2.5 μm, 200 parts by weight of deionized water was added to complete the integration.

### Removal of Organic Solvent

The W/O emulsion liquid containing the integrated particles was placed in an environment under reduced pressure to remove the organic solvent until the solid content reached 23% by weight, thereby providing a slurry (dispersion liquid) of toner mother particles.

### Rinsing (First Rinsing)

The slurry (dispersion liquid) was subjected to solid-liquid separation, and the toner mother particles were subjected repeatedly to re-dispersion (re-slurry) in water and solid-liquid separation to perform rinsing. The rinsing was repeated until the electroconductivity of the supernatant of the slurry reached 20 μS/cm or less.

Thereafter, a wet cake of the toner mother particles (toner mother particle cake) was obtained by suction filtration, and the wet cake was dispersed in water to provide a dispersion liquid (aqueous dispersion liquid) containing the rinsed toner mother particles.

### Surface Modification

1N hydrochloric acid was added to the dispersion liquid (aqueous dispersion liquid) containing the rinsed toner mother particles to adjust the hydrogen ion exponent (pH) thereof to 4.0.

Thereafter, polyethyleneimine (average molecular weight: 70,000) was added dropwise to the dispersion liquid (aqueous dispersion liquid) having a hydrogen ion exponent (pH) adjusted to 4.0 under stirring. The polyethyleneimine was added to make an amount thereof of 1.0 part by weight per 100 parts by weight of the amount of the rosin resins. Furthermore, the mixture was then sufficiently agitated to make a sufficiently homogeneous composition throughout the dispersion liquid.

### Rinsing (Second Rinsing)

The dispersion liquid having the toner particles dispersed therein was subjected to solid-liquid separation, and the toner particles were subjected repeatedly to re-dispersion (re-slurry) in water and solid-liquid separation to perform rinsing. Thereafter, a wet cake of the toner particles (toner particle cake) was obtained by suction filtration. The wet cake thus obtained had a water content of 35% by weight. The liquid phase (supernatant) separated through the solid-liquid separation was investigated, but polyethyleneimine was not detected therein.

### Drying

The resulting wet cake was dried with a vacuum dryer to provide cyan toner particles A having the toner mother particles surface-modified (chemically modified) with polyethyleneimine.

Magenta toner particles A, yellow toner particles A and black toner particles A were produced in the same manner as in the production of the cyan toner particles A except that the cyan pigment was changed to a magenta pigment (Pigment Red 238, produced by Sanyo Color Works, Ltd.), a yellow pigment (Pigment Yellow 180, produced by Clariant Japan Co., Ltd.) and a black pigment (carbon black, Printex L, produced by Degussa AG), respectively.

### Production of Toner Particles B to H

Toner particles B to H were produced in the same manner as in the production of the toner particles A except that the kind and the content of the resin material used and the weight average molecular weight and the amount of the polyethyleneimine used for surface modification were changed as shown in Table 1.

### Production of Toner Particles I

Toner particles I were produced in the same manner as in the production of the toner particles A except that the kind and the content of the resin material used were changed as shown in Table 1, and the surface modification with polyethyleneimine was not performed.

### Production of Toner Particles J

Toner particles J were produced in the same manner as in the production of the toner particles A except that the rosin resin was not used as the resin material, but the contents of the polyester resins L and H were changed as shown in Table

Table 1 shows the contents and the amounts of the materials used for producing the toner particles. In the table, a polyester resin (weight average molecular weight Mw: 5,200, glass transition temperature: 46° C., softening temperature: 95° C., acid value: 10.0 mgKOH/g) is referred to as L, a polyester resin (weight average molecular weight Mw: 237,000, glass transition temperature: 63° C., softening temperature: 182° C., acid value: 9.8 mgKOH/g) is referred to as H, a styrene-acrylate ester copolymer is referred to as ST-AC, a polyester-modified rosin resin (“TF5-015”, a trade name, produced by Arakawa Chemical Industries, Ltd., acid value: 11.8 mgKOH/g, softening point: 79° C., weight average molecular weight: 1,300) is referred to as RPES, a phenol-modified rosin resin (“Tamanol 145”, a trade name, produced by Arakawa Chemical Industries, Ltd., acid value: 18 mgKOH/g or less, softening point: 140 to 155° C., weight average molecular weight: 10,000 to 20,000) is referred to as RPH, a maleic acid-modified rosin resin (“Malkyd No. 1”, a trade name, produced by Arakawa Chemical Industries, Ltd., acid value: 25 mgKOH/g or less, softening point: 120 to 130° C., weight average molecular weight: 3,100) is referred to as RM, and polyethyleneimine is referred to as PEI.

TABLE 1

| | Toner particles | | | | | | | |
|---|---|---|---|---|---|---|---|---|
| | Toner mother particles | | | | | | | |
| | Resin material | | | | | Polyalkyleneimine | | |
| | | | Resin material other | | Presence of | | | Amount used per |
| | Rosin resin | | than rosin resin | | polyalkyleneimine | | Number | 100 parts by |
| | | Content in | | Content in | for | | average | weight of rosin |
| | | resin material | | resin material | surface | | molecular | resin |
| | Kind | (% by weight) | Kind | (% by weight) | modification | Kind | weight | (part by weight) |
| Toner | RPH | 20 | L/H | 60/20 | present | PEI | 70,000 | 1.0 |
| particles A | | | | | | | | |
| Toner | RPH | 30 | L/H | 50/20 | present | PEI | 10,000 | 0.5 |
| particles B | | | | | | | | |
| Toner | RPH | 8 | L/H | 72/20 | present | PEI | 70,000 | 1.0 |
| particles C | | | | | | | | |
| Toner | RPH | 20 | L/H | 60/20 | present | PEI | 100,000 | 0.25 |
| particles D | | | | | | | | |
| Toner | RPH | 20 | L/H | 60/20 | present | PEI | 70,000 | 3.5 |
| particles E | | | | | | | | |
| Toner | RM | 20 | L/H | 60/20 | present | PEI | 70,000 | 1.0 |
| particles F | | | | | | | | |
| Toner | RPES | 20 | L/H | 60/20 | present | PEI | 70,000 | 1.0 |
| particles G | | | | | | | | |
| Toner | RPH | 3 | ST-AC | 97 | present | PEI | 5,000 | 1.0 |
| particles H | | | | | | | | |
| Toner | RPH | 45 | L/H | 35/20 | none | — | — | — |
| particles I | | | | | | | | |
| Toner | — | — | L/H | 80/20 | present | PEI | 70,000 | 1.0 |
| particles J | | | | | | | | |

### Production of Liquid Developer

A liquid developer was produced in the following manner. The processes described with no indication of temperatures were performed at room temperature (25° C.).

### EXAMPLE 1

### Dispersion in Insulating Liquid

37.5 parts by weight of the cyan toner particles A obtained in the aforementioned manner, 3.0 parts by weight of iodonium (4-methylphenyl)(4-(2-methylpropyl)phenyl)-hexafluorophospate as a cationic photopolymerization initiator, 3.0 parts by weight of 9,10-dibutoxyanthracene as a sensitizer, 90 parts by weight of epoxidized soybean oil as an epoxy-modified compound and 60 parts by weight of a soybean oil ester-exchanged liquid produced by ester exchange reaction between soybean oil and methanol (“Methyl Soybean Fatty Acid Ester”, a trade name, produced by The Nisshin OilliO Group, Ltd., viscosity: 5.1 mPa·s) were placed in a ceramic pot (capacity: 600 mL), to which zirconia balls were placed therein to make a volume filling rate of 85%, and the mixture was dispersed with a desktop pot mill at a rotation number of 230 rpm for 24 hours. According to the procedures, a cyan liquid developer was obtained. The epoxidized soybean oil used was obtained by oxidizing (epoxidizing) soybean oil with peracetic acid.

In the resulting liquid developer, the toner particles had a Dv(50) of 1.8 μm. The 50% volume average particle diameter Dv(50) (μm) of the resulting toner particles was measured with a particle analyzer, Mastersizer 2000, produced by Malvern Instruments, Ltd. The particles obtained in Examples and Comparative Examples below were also measured for particle diameters in the same manner.

The resulting liquid developer had a viscosity of 50 mPa·s at 25° C.

A magenta liquid developer, a yellow liquid developer and a black liquid developer were produced in the same manner as above except that the cyan toner particles A was replaced by the magenta toner particles A, the yellow toner particles A and the black toner particles A, respectively.

### EXAMPLES 2 TO 15

Liquid developers corresponding to the colors were produced in the same manner as in Example 1 except that the kinds and the contents of the materials of the liquid developers were changed as shown in Table 3.

### COMPARATIVE EXAMPLE 1

Liquid developers corresponding to the colors were produced in the same manner as in Example 1 except that the rosin resin was not used, and the amount of the polyester resin used was increased in the corresponding amount. The liquid phase (supernatant) separated in the solid-liquid separation in the rinsing procedure (second rinsing) was investigated, and it was found that the polyalkyleneimine was contained therein.

### COMPARATIVE EXAMPLE 2

Liquid developers corresponding to the colors were produced in the same manner as in Example 1 except that liquid paraffin (“Cosmowhite P-70”, a trade name, produced by Cosmo Oil Lubricants Co., Ltd.) was used instead of the epoxidized soybean oil in the insulating liquid.

### COMPARATIVE EXAMPLE 3

Liquid developers corresponding to the colors were produced in the same manner as in Example 1 except that soybean oil (“Soybean Refined Oil”, a trade name, produced by The Nisshin OilliO Group, Ltd.) was used instead of the epoxidized soybean oil in the insulating liquid.

### COMPARATIVE EXAMPLE 4

Liquid developers corresponding to the colors were produced in the same manner as in Example 1 except that the cationic photopolymerization initiator was not used.

Table 2 shows the epoxy-modified compounds used in Examples and Comparative Examples. In Table 2, an epoxidized soybean oil is referred to as Compound A, an epoxidized linseed oil obtained by oxidizing linseed oil with peracetic acid is referred to as Compound B, an epoxidized canola oil obtained by oxidizing canola oil with peracetic acid is referred to as Compound C, an epoxidized canola oil having a different iodine value produced in the same manner as the epoxidized canola oil as Compound C is referred to as Compound D, and an epoxy-modified silicone oil with a part of the polysiloxane side chains and the end methyl groups having been replaced by epoxy group-containing alkyl groups (“X-22-9002”, a trade name, produced by Shin-Etsu Silicone Co., Ltd.) is referred to as Compound E.

Table 3 shows the constitutional materials of the liquid developers and the contents thereof in the liquid developers in Examples and Comparative Examples. In Table 3, iodonium (4-methylphenyl)(4-(2-methylpropyl)phenyl)-hexafluorophospate is referred to as “a”, triphenylsulfonium hexafluorophosphate is referred to as “b”, 9,10-dibutoxyanthracene is referred to as “c”, 9,10-diethoxyanthracene is referred to as “d”, and a polyester resin, “Arakyd 251”, a trade name, produced by Arakawa Chemical Industries, Ltd. is referred to as “e”. The liquid paraffin used was “Cosmowhite P-70” (a trade name, produced by Cosmo Oil Lubricants Co., Ltd.), the soybean oil, the methyl soybean oil fatty acid ester and the methyl canola oil fatty acid ester used were those produced by The Nisshin OilliO Group, Ltd.

TABLE 2
Epoxy-modified compound

Raw material

| | | Iodine | Iodine | |
|---|---|---|---|---|
| | Kind | value I₂ | value I₁ | I₁/I₂ |
| Compound A | soybean oil | 120 | 2 | 0.016 |
| Compound B | linseed oil | 190 | 6 | 0.132 |
| Compound C | canola oil | 100 | 15 | 0.15 |
| Compound D | canola oil | 100 | 18 | 0.18 |
| Compound E | polysiloxane | — | — | — |

TABLE 3

| | Liquid developer | | | | | |
|---|---|---|---|---|---|---|
| | Toner particles | | Insulating liquid | | | |
| | | Content | | Content | | Content |
| | Kind | (% by weight) | Kind | (% by weight) | Kind | (% by weight) |
| Example 1 | toner | 19.4 | Compound A | 46.5 | methyl soybean | 31.0 |
| | particles A | | | | oil fatty acid ester | |
| Example 2 | toner | 19.4 | Compound A | 46.5 | methyl soybean | 31.0 |
| | particles B | | | | oil fatty acid ester | |
| Example 3 | toner | 19.4 | Compound A | 68.2 | methyl soybean | 9.3 |
| | particles C | | | | oil fatty acid ester | |
| Example 4 | toner | 19.4 | Compound A | 46.5 | methyl soybean | 31.0 |
| | particles D | | | | oil fatty acid ester | |
| Example 5 | toner | 19.4 | Compound A | 46.5 | methyl canola oil | 31.0 |
| | particles E | | | | fatty acid ester | |
| Example 6 | toner | 19.4 | Compound A | 46.5 | methyl soybean | 31.0 |
| | particles F | | | | oil fatty acid ester | |
| Example 7 | toner | 19.4 | Compound A | 46.5 | methyl soybean | 31.0 |
| | particles G | | | | oil fatty acid ester | |
| Example 8 | toner | 19.4 | Compound A | 46.5 | methyl soybean | 31.0 |
| | particles H | | | | oil fatty acid ester | |
| Example 9 | toner | 19.4 | Compound A | 45.0 | methyl soybean | 31.0 |
| | particles I | | | | oil fatty acid ester | |
| Example 10 | toner | 19.4 | Compound B | 46.5 | methyl soybean | 31.0 |
| | particles A | | | | oil fatty acid ester | |
| Example 11 | toner | 19.4 | Compound C | 41.8 | methyl canola oil | 35.7 |
| | particles A | | | | fatty acid ester | |
| Example 12 | toner | 19.4 | Compound D | 37.2 | methyl canola oil | 40.3 |
| | particles A | | | | fatty acid ester | |
| Example 13 | toner | 19.4 | Compound E | 71.3 | methyl soybean | 6.2 |
| | particles A | | | | oil fatty acid ester | |
| Example 14 | toner | 19.4 | Compound A | 77.5 | — | — |
| | particles A | | | | | |
| Example 15 | toner | 19.4 | Compound A | 48.0 | methyl soybean | 31.0 |
| | particles A | | | | oil fatty acid ester | |
| Comparative | toner | 19.4 | Compound A | 46.5 | methyl soybean | 31.0 |
| Example 1 | particles I | | | | oil fatty acid ester | |
| Comparative | toner | 19.4 | liquid paraffin | 80.6 | — | — |
| Example 2 | particles A | | | | | |
| Comparative | toner | 19.4 | soybean oil | 80.6 | — | — |
| Example 3 | particles A | | | | | |
| Comparative | toner | 19.4 | Compound A | 48.1 | methyl soybean | 31.0 |
| Example 4 | particles A | | | | oil fatty acid ester | |

| | Liquid developer | | | | | | |
|---|---|---|---|---|---|---|---|
| | Cationic | | | | | | |
| | photopolymerization | | | | | | |
| | initiator | | Sensitizer | | Other component | | |
| | | Content | | Content | | Content | Viscosity |
| | Kind | (% by weight) | Kind | (% by weight) | Kind | (% by weight) | (mPa · s) |
| Example 1 | a | 1.55 | c | 1.55 | — | — | 50 |
| Example 2 | a | 1.55 | d | 1.55 | — | — | 48 |
| Example 3 | b | 1.55 | c | 1.55 | — | — | 48 |
| Example 4 | b | 1.55 | c | 1.55 | — | — | 49 |
| Example 5 | b | 1.55 | c | 1.55 | — | — | 52 |
| Example 6 | b | 1.55 | d | 1.55 | — | — | 55 |
| Example 7 | a | 1.55 | d | 1.55 | — | — | 48 |
| Example 8 | a | 1.55 | d | 1.55 | e | 1.50 | 54 |
| Example 9 | a | 1.55 | d | 1.55 | — | — | 52 |
| Example 10 | a | 1.55 | d | 1.55 | — | — | 48 |
| Example 11 | a | 1.55 | d | 1.55 | — | — | 50 |
| Example 12 | a | 1.55 | c | 1.55 | — | — | 48 |
| Example 13 | a | 1.55 | c | 1.55 | — | — | 54 |
| Example 14 | a | 1.55 | c | 1.55 | — | — | 49 |
| Example 15 | a | 1.60 | — | — | — | — | 52 |
| Comparative | a | 1.55 | c | 1.55 | — | — | 55 |
| Example 1 | | | | | | | |
| Comparative | — | — | — | — | — | — | 47 |
| Example 2 | | | | | | | |
| Comparative | — | — | — | — | — | — | 48 |
| Example 3 | | | | | | | |
| Comparative | — | — | c | 1.55 | — | — | 50 |
| Example 4 | | | | | | | |

### (2) Evaluation

The liquid developers thus obtained were evaluated in the following manners.

### (2-1) Fixing Strength

Images with a prescribed pattern were formed on recording paper (high quality paper, LPCPP A4, produced by Seiko Epson Corporation) with the liquid developers obtained in Examples and Comparative Examples by using the image forming apparatus shown in FIGS. 1 and 2, and the images were fixed by irradiation of an ultraviolet ray under condition of a conveying speed of the recording paper of 320 mm/sec and a radiation energy of the ultraviolet ray radiated onto the images of 70 mJ/cm² (condition 1).

Thereafter, the non-offset area was confirmed, and the fixed images obtained with the liquid developers obtained in Examples and Comparative Examples were rubbed twice with a rubber eraser (a sand eraser, “LION 261-11”, produced by Lion Office Products Corporation) under a pressing load of 1.5 kgf. The remaining ratio of the image density was measured with “X-Rite Model 404”, produced by X-Rite, Inc., and evaluated by the following five grades.
A: remaining ratio of image density of 95% or more (excellent)
B: remaining ratio of image density of 90% or more and less than 95% (good)
C: remaining ratio of image density of 80% or more and less than 90% (allowable)
D: remaining ratio of image density of 70% or more and less than 80% (slightly poor)
E: remaining ratio of image density of less than 70% (poor)

Images with a prescribed pattern were formed on recording paper (high quality paper, LPCPP A4, produced by Seiko Epson Corporation) with the liquid developers obtained in Examples and Comparative Examples by using the image forming apparatus shown in FIG. 4. The images were fixed by application of heat, pressure and irradiation of an ultraviolet ray under condition of a nip pressure of the heating roller F41 of 3.5 kgf/cm², a temperature of the heating roller F41 of 130° C., a radiation energy of the ultraviolet ray radiated onto the images of 70 mJ/cm² and a conveying speed of the recording paper of 320 mm/sec (condition 2), and evaluated in the same manner as above.

### (2-2) Anti-Blocking Property of Fixed Printed Surface

The toners obtained in Examples and Comparative Examples were evaluated for resistance to blocking (anti-blocking property) in the following manner.

An image forming apparatus having the structure shown in FIGS. 1 and 2 was prepared. A monochrome toner image with a prescribed pattern was formed on recording paper (high quality paper, LPCPP A4, produced by Seiko Epson Corporation) by using the image forming apparatus to make a toner weight of the toner image formed on the recording paper of 0.75 mg/cm². The recording paper having the toner image formed thereon was fixed under the same condition as the condition 1 in the item (2-1) with a conveying speed of the recording paper of 320 mm/sec, thereby providing a toner image.

Two sheets of the recording paper having the images formed thereon were superimposed on each other with the fixed toner images being in close contact with each other, and the fixed toner images formed on the recording paper were closely attached to each other at a temperature of 55° C. under application of a load of 1.0 kgf/cm² by placing a weight on the recording paper for 24 hours. Thereafter, the weight was removed from the recording paper, and the recording paper was cooled to room temperature (25° C.).

After cooling, two sheets of the recording paper were released from each other, thereby releasing the fixed toner images, which had been closely attached to each other, from each other. The fixed toner images thus released were visually confirmed to evaluate the presence of attached powder, unevenness in gloss, unevenness in density and the like by the following four grades.

A: attached powder, unevenness in gloss and unevenness in density completely not found on fixed toner image

B: attached powder, unevenness in gloss and unevenness in density substantially not found on fixed toner image

C: attached powder, unevenness in gloss and unevenness in density slightly found on fixed toner image

D: attached powder, unevenness in gloss and unevenness in density clearly found on fixed toner image

Toner images were obtained by fixing under the same condition as the condition 2 in the item (2-1) and evaluated in the same manner as above, provided that the load applied to the two sheets of the recording paper for closely attaching the fixed toner images formed thereon was changed to 1.2 kgf/cm².

### (2-3) Dispersion Stability Test

### (2-3-1) Method 1

10 mL of the liquid developers obtained in Examples and Comparative Examples each were placed in a test tube (bore diameter: 12 mm, length: 120 mm) and allowed to stand for 10 days. The sedimentation depth (i.e., the distance from the liquid surface to the surface formed by sedimentation of the toner particles) was measured and evaluated by the following four grades.

A: sedimentation depth of 0 mm

B: sedimentation depth of more than 0 mm and 2 mm or less

C: sedimentation depth of more than 2 mm and 5 mm or less

D: sedimentation depth of more than 5 mm

### (2-3-2) Method 2

45.5 mL of the liquid developers obtained in Examples and Comparative Examples each were placed in a centrifugal separation tube and then subjected to centrifugal separation at a rotation radius of 5 cm and a rotation number of 500, 1,000, 2,000, 4,000 or 5,000 rpm for 3 minutes with a centrifugal separator (produced by Kokusan Co., Ltd.). Thereafter, the sedimentation depths at the respective rotation numbers were measured.

The measurement results were plotted on a graph with the centrifugal acceleration rω² (ω²=1,118×rotation radius (cm)×rotation number per minute (rpm)²×10⁻⁸×g (gravity acceleration)) as the abscissa and the sedimentation depth as the ordinate. The gradient k was obtained from the plots by primary approximation and evaluated by the following four grades. A smaller value of k means higher dispersion stability.

0≦k<0.004 A:

0.004≦k<0.008 B:

0.008≦k<0.012 C:

k≧0.012 D:

### (2-4) Evaluation of Gloss of Toner Images

The liquid developers obtained in Examples and Comparative Examples were applied to an image forming apparatus shown in FIGS. 1 and 2 to form images with a prescribed pattern on recording paper (high quality paper, LPCPP A4, produced by Seiko Epson Corporation), which were fixed by irradiation of an ultraviolet ray under condition of a conveying speed of the recording paper of 320 mm/sec and a radiation energy of the ultraviolet ray radiated onto the images of 70 mJ/cm². The images thus obtained on the recording paper were measured for gloss with a gloss meter (“GM-26D”, produced by Murakami Color Research Laboratory Co., Ltd.).

The liquid developers obtained in Examples and Comparative Examples were applied to an image forming apparatus shown in FIG. 4 to form images with a prescribed pattern on recording paper (high quality paper, LPCPP A4, produced by Seiko Epson Corporation), which were fixed by application of heat and irradiation of an ultraviolet ray under condition of a temperature of the heating roller F41 of 115° C., a conveying speed of the recording paper of 320 mm/sec and a radiation energy of the ultraviolet ray radiated onto the images of 70 mJ/cm². The images thus obtained on the recording paper were measured for gloss with a gloss meter (“GM-26D”, produced by Murakami Color Research Laboratory Co., Ltd.).

The gloss G1 of the image formed on the recording paper by using the image forming apparatus shown in FIGS. 1 and 2 and the gloss G2 of the image formed on the recording paper by using the image forming apparatus shown in FIG. 4 were compared for each of Examples and Comparative Examples, and the results were evaluated by the following four grades.

G2−G1≧4.0 A:

2.5≦G2−G1<4.0 B:

1.0≦G2−G1<2.5 C:

G2−G1≦1.0 D:

The results obtained are shown in Table 4.

TABLE 4

| | | | Anti-blocking | | Dispersion | | |
|---|---|---|---|---|---|---|---|
| | Fixing strength | | property | | stability | | |
| | Condition 1 | Condition 2 | Condition 1 | Condition 2 | Method 1 | Method 2 | Gloss |
| Example 1 | A | A | A | A | A | A | A |
| Example 2 | A | A | A | A | A | A | A |
| Example 3 | A | A | A | A | A | A | A |
| Example 4 | B | A | B | A | A | B | A |
| Example 5 | A | A | A | A | A | B | A |
| Example 6 | A | A | A | A | A | A | A |
| Example 7 | A | A | A | A | A | A | A |
| Example 8 | C | B | B | B | B | B | B |
| Example 9 | B | B | B | B | B | B | A |
| Example 10 | A | A | A | A | A | A | A |
| Example 11 | A | A | A | A | A | A | A |
| Example 12 | B | A | B | A | A | B | A |
| Example 13 | B | B | B | B | A | B | B |
| Example 14 | B | B | B | A | A | A | B |
| Example 15 | B | A | A | A | A | A | A |
| Comparative | D | C | D | C | D | D | A |
| Example 1 | | | | | | | |
| Comparative | E | D | D | D | A | B | A |
| Example 2 | | | | | | | |
| Comparative | E | C | D | D | B | B | A |
| Example 3 | | | | | | | |
| Comparative | D | D | D | C | A | A | A |
| Example 4 | | | | | | | |

It was understood from Table 4 that the liquid developers according to the embodiments of the invention were excellent in fixing strength and anti-blocking property. Accordingly, the liquid developers according to the embodiments of the invention were excellent in fixing property. The liquid developers according to the embodiments of the invention were excellent in dispersion stability of the toner particles. On the other hand, the liquid developers of Comparative Examples provided insufficient results.

Toner images were formed with the liquid developers of Comparative Examples by using the image forming apparatus shown in FIG. 4, and then fixed without irradiation of an ultraviolet ray. The images were evaluated in the same manner as in the items (2-1) and (2-2), and the similar results as in the case where the images were fixed with irradiation of an ultraviolet ray were obtained.

Images were formed with the liquid developers of Examples by using the image forming apparatuses shown in FIG. 1 and FIG. 4. As a result, the image formed by using the image forming apparatus shown in FIG. 4 was excellent in coloring property as compared to the image formed by using the image forming apparatus shown in FIG. 1.

What is claimed is:

1. A liquid developer comprising:
toner particles containing a rosin resin;
an insulating liquid containing an epoxy-modified compound in liquid form; and
a cationic photopolymerization initiator.

2. The liquid developer as claimed in claim 1, wherein the toner particles contain a polyester resin, in addition to the rosin resin.

3. The liquid developer as claimed in claim 1, wherein the toner particles contain toner mother particles containing the rosin resin having been surface-modified with a polyalkyleneimine.

4. The liquid developer as claimed in claim 3, wherein the polyalkyleneimine is polyethyleneimine.

5. The liquid developer as claimed in claim 1, wherein the epoxy-modified compound is an epoxidized vegetable oil obtained by epoxy-modifying a vegetable oil.

6. The liquid developer as claimed in claim 5, wherein the vegetable oil to be epoxy-modified contains as a constitutional component an unsaturated fatty acid having two or more unsaturated double bonds.

7. The liquid developer as claimed in claim 5, wherein the liquid developer satisfies the relationship, 0≦I₁/I₂≦0.17 and 70≦I₂≦220, wherein I₁ represents an iodine value of the epoxidized vegetable oil, and I₂ represents an iodine value of the vegetable oil before being epoxy-modified.

8. The liquid developer as claimed in claim 1, wherein the insulating liquid contains a fatty acid monoester.

9. The liquid developer as claimed in claim 1, wherein the cationic photopolymerization initiator is an aromatic sulfonium salt or an aromatic iodonium salt.

10. The liquid developer as claimed in claim 1, wherein the insulating liquid further contains a sensitizer.

11. The liquid developer as claimed in claim 1, wherein the rosin resin contains at least one of a maleic acid-modified rosin resin, a phenol-modified rosin resin and a polyester-modified rosin resin.

12. An image forming method comprising:
forming plural monochrome image of plural colors with plural liquid developers corresponding to the plural colors respectively;
transferring the plural monochrome images of the plural colors to a recording medium, thereby forming on the recording medium an unfixed color image containing the plural monochrome images superimposed on each other; and
irradiating the unfixed color image with an ultraviolet ray, thereby fixing the unfixed color image to the recording medium,
the liquid developer comprising toner particles, an insulating liquid mainly containing an epoxy-modified compound in liquid form, and a cationic photopolymerization initiator.

13. The image forming method as claimed in claim 12, wherein the ultraviolet ray, with which the unfixed color image is irradiated, has an irradiation energy of from 25 to 500 mJ/cm², and the recording medium is conveyed at a speed of from 50 to 1,000 mm/sec in the fixing.

14. The image forming method as claimed in claim 12, wherein upon irradiating the unfixed color image with an ultraviolet ray for fixing the unfixed image, the unfixed image is applied with heat and pressure simultaneously in the fixing.
